(19) United States
(12) Patent Application Publication
(10) Pub. No.: US 2026/0146375 A1
(43) Pub. Date: May 28, 2026

(54) MULTI-ZONE THERMOFORMED SEAMLESS KNITTED TEXTILE PANEL

(71) Applicant: Amer Sports Canada Inc., North Vancouver (CA)

(72) Inventors: Gregory R. Grenzke, Ojai, CA (US); Skylar Tibbets, Nahant, MA (US); Lavender Tessmer, Clemson, SC (US)

(73) Assignee: Amer Sports Canada Inc., North Vancouver (CA)

(21) Appl. No.: 19/402,504

(22) Filed: Nov. 26, 2025

Related U.S. Application Data
(60) Provisional application No. 63/725,702, filed on Nov. 27, 2024.

(51) Int. Cl. D04B 1/20; D04B 1/02; D04B 1/24

(52) U.S. Cl. CPC D04B 1/20; D04B 1/02; D04B 1/246; D10B 2321/021; D10B 2501/04

(57) ABSTRACT

A multi-zone thermoformed seamless knitted textile panel includes a knitted flexible insulation zone comprising crimped and bulked fibers and a knitted shaped zone comprising a three-dimensional structural layer.

### CROSS-REFERENCE TO RELATED PATENT APPLICATIONS

The present application claims the benefit of U.S. provisional patent application Ser. No. 63/725,702 filed on Nov. 27, 2024, and entitled GARMENT KNITTED INSULATION, the full disclosure of which is hereby incorporated by reference.

### BACKGROUND

Textiles are used to manufacture a wide a variety of textile items such as garments, bags, backpacks, running belts, towels, sleeping bags, blankets and bed linens. For some items, especially clothing garments, multiple pieces or panels must be cut, shaped and sewn together. Some textile items additionally include layers of insulation. For example, coats, jackets, bags, sleeping and blankets may often include one or more layers of nonwoven insulation. Due to the multiple number of pieces, the shaping of such pieces and the need to join such pieces, the manufacturer of many textile items involves complex manufacturing equipment and time-consuming and costly processes.

### BRIEF DESCRIPTION OF THE DRAWINGS

FIG. 1 is a perspective view illustrating an example filament.

FIG. 2 is a perspective view illustrating an example fiber.

FIG. 3 is a perspective view illustrating an example yarn.

FIG. 4 is effective view illustrating an example stitch.

FIG. 5 is a perspective view illustrating an example textile.

FIG. 6 is a front perspective view of an example garment comprising an example multi-zone thermoformed seamless knitted textile panel.

FIG. 7 is a rear perspective view of the example garment.

FIG. 8 is a sectional view of the example garment of FIG. 6 taken along line 8-8.

FIG. 9 is a sectional view of the example garment of FIG. 7 taken along line 9-9.

FIG. 10 is a sectional view of the example garment of FIG. 6 taken along line 10-10.

FIG. 11 is a sectional view of the example garment of FIG. 7 taken along line 11-11.

FIG. 12 is a sectional view of a non-insulated zone of the example garment of FIG. 6.

FIG. 13 is a sectional view of an example stay or mounting zone of the garment of FIG. 6.

FIG. 14 is a sectional view of an example multi-zone seamless knitted textile panel prior to thermoforming.

FIG. 15 is a top view illustrating thermoforming of the example panel of FIG. 14.

FIG. 16 is a front perspective view of an example garment.

FIG. 17 is a front perspective view of the example garment of FIG. 16.

FIG. 18 is a rear perspective view of the example garment of FIG. 16.

FIG. 19 is a rear perspective view of the example garment of FIG. 16 without an exterior layer.

FIG. 20 is a perspective view of an example yarn for forming the panel of the garment of FIG. 16.

FIG. 21 is a perspective view of the example yarn of FIG. 20 prior to thermoforming.

FIG. 22 is a perspective view of the example yarn of FIG. 20 following thermoforming.

FIG. 23 is a perspective view of an example yarn for forming the panel of the garment of FIG. 16.

FIG. 24 is a perspective view of an example yarn forming the panel of the garment of FIG. 16.

FIG. 25 is a rear perspective view of an example multi-zone seamless knitted textile torso panel and example multizone seamless knitted textile sleeve panels, prior to thermoforming, for forming portions of the example jacket of FIG. 16.

FIG. 26 is an enlarged perspective view illustrating a liner layer and an example insulation layer of an example liner insulation zone of the panel of the garment of FIG. 16, prior to thermoforming.

FIG. 27 is an enlarged perspective view illustrating the liner layer and the example insulation layer of FIG. 26 following thermoforming.

FIG. 28 is a rear perspective view of an example mandrel for shaping the example panels of FIG. 25 during heating/thermoforming.

FIG. 29 is a rear perspective view of the example panels of FIG. 25 following heating/thermoforming on the example mandrel of FIG. 28.

FIGS. 30A, 30B, 30C, 30D and 30E are perspective views of a portion of the mandrel of FIG. 28 and how it is used to shape a structural insulation zone of the torso panel of FIG. 25. FIG. 30A is a top perspective view illustrating positioning of an example seamless knitted textile panel onto textile grips of a lower plate. FIG. 30B is a top perspective view illustrating the positioning of a top plate, sandwiching the seamless knitted textile panel between the top plate and the bottom plate. FIG. 30C is a top perspective view illustrating the example textile grips, in the form of example pins, passing through the top plate. FIG. 30D is a top perspective view illustrating positioning of a retainer positioned over the top plate and in engagement with the textile grips. FIG. 30E is a bottom perspective view of the assembly shown in FIG. 30D.

FIG. 31A is a perspective view of a portion of the example torso panel of FIG. 25 following thermoforming and shaping with the mandrel of FIG. 28.

FIG. 31B is a perspective view of a portion of another example panel following thermoforming and shaping with a mandrel.

FIG. 31C is a perspective view of a portion of another example panel following thermoforming and shaping with a mandrel.

FIG. 32 is an enlarged perspective view of a portion of the panel of FIG. 29, illustrating an example stay zone and liner insulation zone.

FIG. 33 is an enlarged perspective view of a portion of the panel of FIG. 29 illustrating an example stay zone and support zone.

FIG. 34 is an enlarged perspective view of a portion of the panel of FIG. 29 illustrating a juncture of an example structural insulation zone and liner insulation zone prior to thermoforming.

FIG. 35 is an enlarged perspective view of the portion of the panel shown in FIG. 34 illustrating the juncture of the example structural insulation zone and the example liner insulation zone following thermoforming.

FIG. 36 is an enlarged perspective view of a liner layer of the example structural insulation zone of FIG. 35.

FIG. 37 is an enlarged perspective view of an insulation layer of the example structural insulation zone of FIG. 35.

FIG. 38 is an enlarged perspective view illustrating portions of the example panel of FIG. 29 illustrating the example structural insulation zone, the example liner insulation zone and the example stay zone.

FIG. 39 is a rear perspective view of an example backpack.

FIG. 40 is a rear view of the example backpack of FIG. 39.

FIG. 41 is a right side view of the example backpack of FIG. 39.

FIG. 42 is a simple light schematic diagram of the backpack of FIG. 39 illustrating provision of multizone thermoformed seamless knitted textile panels.

FIG. 43 is a sectional view of the backpack of FIG. 42 taken along line 43-43.

FIG. 44 is a sectional view of the example backpack of FIG. 42 taken along line 44-44.

FIG. 45 is a sectional view of an example backpack taken along line 44-44 of FIG. 42 without an external layer and with an internal layer.

FIG. 46 is a perspective view of an example sleeping bag in a fully open state.

FIG. 47 is a sectional view of the sleeping bag of FIG. 46 taken along line 47-47.

FIG. 48 is a sectional view of the sleeping bag of FIG. 46 in a closed or zipped state taken along line 48-48.

FIG. 49 is a sectional view of an example sleeping bag in a closed or zipped state, taken along line 48-48.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example multi-zone knitted textile panels that may be thermoformed to provide a single individual seamless knit textile panel with distinct zones having distinct shapes, distinct degrees of stiffness, and/or distinct thermal insulation or cushioning properties. A single multizone seamless knitted textile panel may be used to form of a textile item and provide the textile item with different customized properties in different regions. For example, a single example seamless multizone knitted textile panel may have different zones that provide a garment or portions of a garment with (1) a stiffer zone serving as a support structure or a stay to which other panels may be sewn or otherwise affixed, (2) a shaped zone having a preset and established three-dimensional, non-planar shape, and/or (3) an insulated zone having a larger bulk of crimped insulating fibers. In some implementations, the single example seamless multizone knitted textile panel may provide the garment with a zone where the knit textile is both shaped and provided with a larger bulk of crimped insulating fibers.

The example multizone knitted textile panels comprise various combinations of yarns having different tensile and melting point/thermoforming properties. The different yarns are knit using intarsia to control and vary the yarn composition of different regions or zones of an individual seamless textile panel. During thermoforming, the application of heat causes those yarns that are at least partially thermoplastic to soften, to at least partially melt and to potentially fuse to one another. Those zones of the individual textile panel having a larger ratio of thermoplastic plies to non-thermoplastic plies at least partially melt and fuse to one another to form a stiffer layer of the knit textile. This stiffer layer may serve as a structural support or may serve as a stay to which other panels may be sewn or otherwise affixed.

In some implementations, during thermoforming, those yarns that are at least partially thermoplastic may be shaped while in a softened state. In some implementations, prior to thermoforming, the textile item or portions of the textile item having the multizone seamless knitted panel is positioned about a mandrel having a predefined target shape for the panel. The textile item is heated while positioned about or against the mandrel, wherein the textile panel shrinks or otherwise conforms to the shape of the mandrel, assuming the shape of the surface of the mandrel against which the textile panel abuts. Upon cooling, such yarns, forming a particular zone of the single seamless knit panel, cause the particular shaped zone to retain its defined shape. The stiffness of the defined shape and the ability of the zone to retain its defined shape may be controlled by controlling the ratio of thermoplastic fibers/yarns to non-thermoplastic fibers/yarns in the zone. Such shapes may provide the particular zone with an enlarged thicknesses or dimensions, enhanced airflow for temperature control, and/or spacing for cushioning.

In some multizone knitted textile panels, the panel may comprise a zone having a layer formed by a lower ratio of thermoplastic fibers/yarns to non-thermoplastic fibers/yarns. In some implementations, the non-thermoplastic fiber/yarns are formed by cross-linked thermoset materials or other materials that are not thermoplastic at any temperature. In some implementations, the “non-thermoplastic” fibers/yarns may be thermoplastic at some temperatures, but not at the temperatures reached during thermoforming of the textile item. In other words, the non-thermoplastic fibers/yarns may have a melting point greater than the melting point of the different “thermoplastic” fiber/yarns. This difference in the melting point temperatures of the two different fiber/yarns permits the selective application of heat to a selected or controlled temperature such that the thermoplastic fibers/yarns soften and melt during thermoforming while the non-thermoplastic fibers/yarns do not soften or melt as the heat applied during thermoforming. Because there is a lesser number of thermoplastic fibers to melt and fuse, the ultimate stiffness of the layer, following the application of heat, is more defined by the stiffness of the non-thermoplastic fibers/yarns. As result, this layer may be more flexible to provide portions of the textile item with greater flexibility, bend ability or range of motion. This layer may also be softer, being well suited for serving as a liner or a softer surface of the textile item.

In some multizone knitted textile panels, the panel may comprise a zone comprising a combination of both insulating fibers and thermoplastic fibers. The zone may comprise yarns comprising plies of insulating fibers and plies of at least partially thermoplastic fibers. During thermoforming, those at least partially thermoplastic fibers or the at least partially thermoplastic plies tend to shrink. Because the thermoplastic fibers or plies are physically connected to the insulating fibers or plies (through twisting to form the yarn), shrinking of the thermoplastic fibers or plies, or crimping of the insulating fibers or plies, increasing the bulk or volume of such yarns (loft yarns) to provide the particular zone of the textile item with loft and enhanced thermal insulation properties.

As indicated above, during thermoforming, those at least partially thermoplastic fibers or the yarns formed by such fibers tend to shrink. As a result, during thermoforming, the example multizone knitted textile panels assume the shape of adjacent tooling or of an adjacent mandrel. Because the final shape of the single multizone knitted textile panel may be controlled through the use of a particular shaped tool or mandrel and the ratio or concentration of thermoplastic fibers in a particular zone, the single multizone knitted textile panel may provide the textile item with more complex shapes, wherein such complex shapes would otherwise demand the cutting and joining of multiple distinct or panels.

Each individual multizone knitted textile panel offers a combination of distinct customizable zones for a textile item. Some zones may have a softer flexible layer (formed by knit yarns having a lower ratio of thermoplastic plies to non-thermoplastic plies) supporting or backing an insulating layer (formed by yarns having the crimped insulating fibers). Some zones may have a single stiff layer (formed by knit yarns having a higher ratio of thermoplastic plies to non-thermoplastic plies) serving as a stay or as a supporting structure of the panel. Some zones may have a stiff layer (formed by yarns having a higher ratio of thermoplastic plies to non-thermoplastic plies) supporting or backing an insulating layer (formed by yarns having the crimped insulating fibers). Each of such zones is provided in a single seamless knitted textile pattern. Each of such zones may provide without the need to cut and join multiple distinct pieces. As a result, the cost and complexity for manufacturing a textile item may be reduced.

Conventional manufacturing of garments employing nonwoven insulation produces large amounts of waste as multiple pattern pieces must be cut to provide different performance characteristics (different insulation thicknesses) in different regions of a garment. Disclosed are example garments that incorporate individual woven or knitted insulation panels that provide multiple distinct functionalities or performance attributes in different zones of a single, individual panel, reducing the number of panels or pieces needed to provide distinct performance attributes in different regions of a garment. As a result, garment complexity and manufacturing waste are both reduced.

Disclosed are example garments, volume knitted shaped panels for garments, volume knitted insulation panels for garments and methods for forming such articles. Disclosed are examples where a continuous uninterrupted or seamless panel of volume knitted material may be treated, such as with heat, moisture and the like, to achieve varying performance characteristics across different zones or regions of the panel. Some regions may provide insulation. Different regions may provide different degrees of insulation. Some regions may provide a rigid, sustaining three-dimensional shape. Some regions may provide a semi-rigid layer. Some regions may form an embedded stiff region serving as stays, to which other structures may be attached to the panel.

In some implementations, the example panels are formed from different fibers formed from compatible thermoplastic polymers. In some implementations, the example panels are formed from different forms of the same thermoplastic polymer. In other words, the panels are mono material. As result, the panels may be more suited for recycling. In addition, the individual different fibers may be better chemically bonded or fused to one another. In some implementations, the panels are formed from a thermoplastic polymer material such as polyethylene terephthalate.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

For purposes of this disclosure, the phrase “configured to” denotes an actual state of configuration that fundamentally ties the stated function/use to the physical characteristics of the feature proceeding the phrase “configured to”.

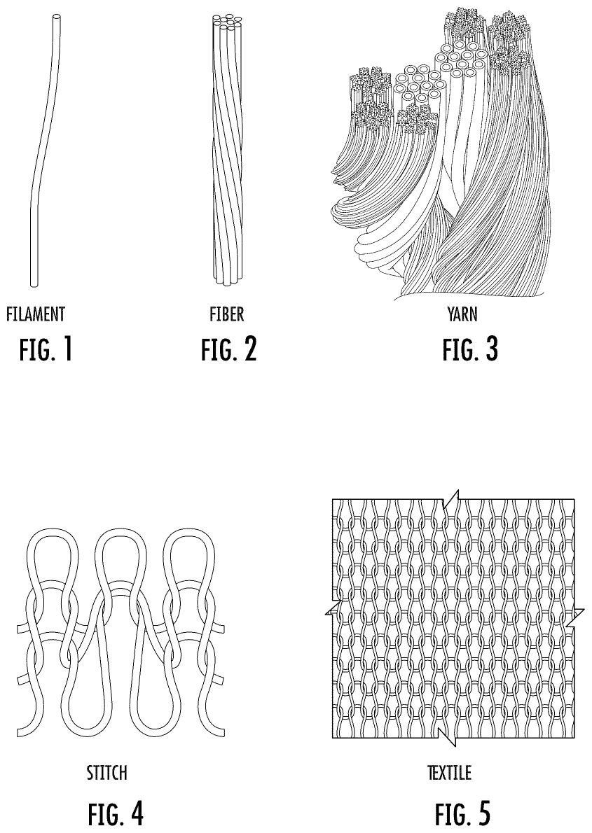

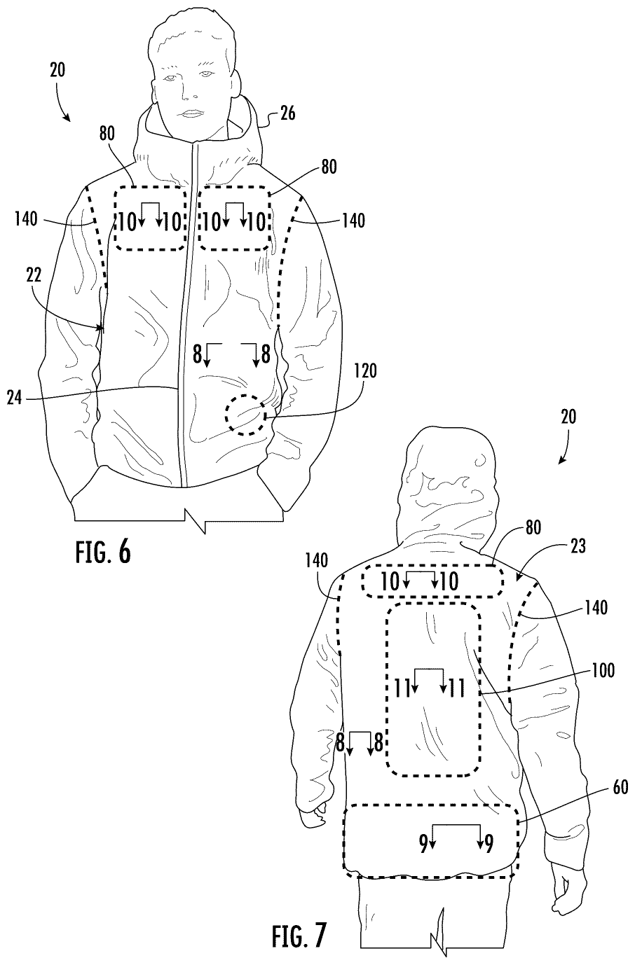

Throughout this disclosure, the term filament, fiber, yarn, stitch and textile may be used. For purposes of this disclosure, the terms “filament”, “fiber”, “yarn”, “stitch” and “textile” refer to a hierarchy of multi-scaler elements that may be interrelated, as depicted in FIGS. 1-5, respectively. FIGS. 1-5 illustrate examples of such elements. For example, a “fiber” may comprise any of a number of different fiber configurations with different numbers of filaments of the same or different materials. A “fiber”, sometimes referred to as a “ply” may comprise a twist or bundle of filaments. Likewise, the term “yarn” may refer to any number of fibers of the same or various compositions. Although the example stitch is illustrated as a tuck stitch, the term “stitch” may encompass any of a number of different types of stitches including, but not limited to, a front stitch, a back stitch, a float stitch, or combinations of different stitch types. Although FIG. 5 illustrates one particular textile form from one particular type of stitch, the term “textile” encompasses any set of a particular type of stitch or a combination of different types of stitches.

For purposes of this disclosure, the phrase “configured to” denotes an actual state of configuration that fundamentally ties the stated function/use to the physical characteristics of the feature proceeding the phrase “configured to”.

Although the following description describes different examples of a multi-zone thermoformed seamless knitted textile panel used to form a garment in the form of a coat or jacket, it should be appreciated that the disclosed panel may likewise be used to form other articles of clothing or other garments. Likewise, the disclosed example panels may be utilized to form at least portions of other textile items, including, but not limited to bags, backpacks, running packs, running belts, climbing harnesses, shoes, blankets, towels, sleeping bags, and bed linens.

FIGS. 6 and 7 illustrate an example garment 20 in the form of a jacket. As schematically shown by broken lines, garment 20 may comprise multiple different regions or zones that exist in the same seamless volume knitted panel or layer. For the purposes of this application, one definition for the term “volume knitting” is seamless and independently variable layers within a knitted textile structure”. As shown by FIGS. 6 and 7, the front 22 may include a zipper 24 for opening and closing the front of the garment. Garment 20 may additionally include a hood direction. In some implementations, hood 26 may be omitted.

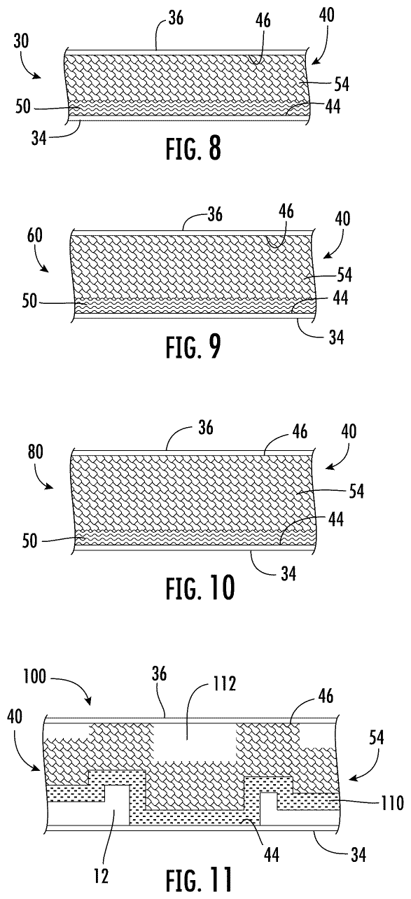

FIG. 8 is a sectional view through particular portions along the front 22 and the rear 23 of garment 20. FIG. 8 is a sectional illustrating portions of a first zone 30 which may extend along a majority of garment 20. Zone 30 comprises an inner layer 34, an outer layer 36 and a volume knitted layer or panel 40. Inner layer 34 comprises one or more layers of material which are to be positioned against the body or skin of the person wearing the garment 20. Outer layer 36 comprises one or more layers of material which are on the outermost exterior of garment 20. Outer layer 36 may be water imperforate, wind resistant and/or breathable. In some implementations, one or both of layers 34 and 36 may be omitted.

Volume knitted layer or panel 40 comprises a volume knitted textile following characteristic or performance defining treatment. Volume knitted panel 40 has varying attributes across its thickness. Panel 40 serves as an insulation panel for garment 20. Panel 40 has a fabric face 44 and an outer face 46. Fabric face 44 faces towards the person wearing garment 20 while outer face 46 faces away from the body of the person wearing garment 20.

Fabric face 44 comprises a first yarn 50 comprising a twist of a combination of a first number of high tenacity thermoplastic fibers and a second smaller number of low temperature melt thermoplastic fibers. The high tenacity thermoplastic fibers provide tensile strength and the low temperature melt thermoplastic fibers, upon application of heat, melt to provide stiffness. The low temperature melt thermoplastic fibers melt at a lower temperature as compared to the high tenacity thermoplastic fibers. The application of heat is controlled such that melting, or shrinkage of the high tenacity thermoplastic fibers is limited or prevented. In some implementations, the high tenacity thermoplastic fibers can be replaced with other materials, such as Nylon. The typical construction of such materials, such as Nylon, has sufficient tensile strength to withstand the knitting process even with very fine-weight yarns. Regardless of the strength of the materials, the differentiated high and low melting points are an important attribute of such implementations.

Outer face 46 comprises a second yarn 54 comprising a twist of a combination number of fibers having hollow cores and a second smaller number of the low temperature melt thermoplastic fibers. Upon treatment by heat, the low temperature melt thermoplastic shrinks, causing the hollow core fibers to crimp and bulk so as to capture air and function as insulation. The low temperature melt thermoplastic fibers are configured to melt at a lower temperature as compared to the hollow core fibers. The application of heat is controlled so as to melt or shrink the low temperature melt thermoplastic fibers but limit or prevent melting or shrinking of the hollow core fibers. In some implementations, the low temperature melt thermoplastic fibers employed in yarns 50 and 54 are the same or are compatible. In some implementations, the low temperature melt thermoplastic fibers are formed from polyethylene terephthalate. In some implementations, the hollow core fibers and the high tenacity thermoplastic fibers are all different forms of polyethylene terephthalate. In some implementations, panel 40 exhibits a thermal insulation performance of at least 0.45 clo/100 g.

FIG. 9 is a sectional view illustrating portions of an example zone 60 having different properties as compared to zone 30. Zone 60 is similar to zone 30 except that zone 60 has a greater amount of yarn 54 as compared to zone 30 to provide enhanced insulation performance. In some implementations, panel 40 of zone 60 exhibits a thermal insulation performance of at least 0.66 clo/100 g.

FIG. 10 is a sectional view illustrating portions of an example zone 80 having different properties as compared to zone 30. Zone 80 is similar to zone 30 except that zone 80 has a greater amount of yarn 54 as compared to zone 60 to provide enhanced insulation performance. In some implementations, panel 40 of zone 80 exhibits a thermal insulation performance of at least 0.80 clo/100 g.

FIG. 11 is a sectional illustrating portions of an example zone 100 which may extend along a back portion, face or side of garment 20, along the back of a person wearing garment 20. Zone 100 is especially useful for providing a rigid three-dimensional shape along the back of the person wearing garment 20, the shape providing spacing and airflow between the back of the person wearing garment 20 and a lower weight bearing against or extending along the back of the person wearing garment 20, such as a backpack or the like. Zone 100 comprises an inner liner 34, outer liner 36 and a volume knitted layer or panel 40. Inner layer 34 and outer layer 36 are described above. In some implementations, one or both of layers 34 and 36 may be omitted.

As described above with respect to zones 30, 60 and 80, volume knitted layer or panel 40 comprises a volume knitted textile following characteristics or performance defining treatment. Volume knitted panel 40 has varying attributes across its thickness. Fabric face 44 of zone 100 comprises yarn 54 comprising a twist of a combination of a first number of fibers having a hollow core and a second smaller number low temperature melt thermoplastic fibers. Although yarn 54 is the same as the yarn 54 in zones 30, 60 and 80, in other implementations, yarn 54 may comprise a different yarn for insulation or a non-insulating yarn, such as yarn 50.

Fabric face 44 comprises a yarn 110 comprising a twist of a combination of a first number of the high tenacity fibers and a second larger number of the low temperature melt thermoplastic fibers. Yarn 110 is configured to be thermoformed. Yarn 110 is configured to be molded or shaped to a desired profile and maintain the molded profile upon cooling. Yarn 110 is configured to enable shape transformation in response to heat, preferably convection heat. Yarn 110 is configured to attain the malleable or shape transformation state in response to heat and at the same time because the same low temperature melt thermoplastic fibers to shrink, causing the hollow core fibers of yarn 54 to bulk and crimp. As result, shaped yarn 110 supports the otherwise flexible yarn 54 in the three-dimensional shape and in an insulating state.

Although FIG. 11 illustrates one example three-dimensional shape for yarn, in other implementations, yarn 110 may be molded to other shapes. As shown by FIG. 6, following such shaping, yarn 110 forms open volumetric spaces or gaps 112 to provide airflow between liners 34, 36 and between the back of the person wearing garment 20 and any adjacent load, such as a backpack. The preferred method of thermoforming the zoned knits and thermoformed areas is to use convention as the heating process. Heating via convection enables desired degrees or levels of loft to be retained in the yarn, zoned knitted areas and/or thermoformed areas.

As shown by FIGS. 8-11, the seamless volume knitted layer, or panel has several different regions of different performance characteristics. The garment panel 40 comprises a fabric face 44 and an outer face 46, wherein the fabric face 44 of the knitted rigidly shaped zone 100 comprises yarn 54, wherein the outer face 44 of the knitted rigidly shaped zone 100 comprises yarn 110, wherein the fabric face 44 of the knitted flexible insulation zone 30, 60, 80 comprises yarn 50 and wherein the outer face 44 of the knitted flexible insulation zone 30, 60, 80 comprises the first yarn 54. In some implementations, the yarn 110 has a first degree of stiffness and a first extent of crimped and bulked fibers, wherein the yarn 54 has a second degree of stiffness less than the first degree of stiffness, the yarn 54 having a second extent of crimped and bulked fibers greater than the first extent of crimped involved fibers, and wherein the yarn 50 has a third degree of stiffness less than the first degree of stiffness and greater than the second degree of stiffness, the yarn 50 having a third extent of crimped and bulked fibers less than the second extent of crimped involved fibers. The yarn 110 and the yarn 50 each comprise a first fiber having a first tensile strength and a first melting temperature and a second fiber having a second tensile strength less than the first tensile strength and a second melting temperature less than the first melting temperature, wherein the first yarn 110 has a larger percentage of the second fibers than the first fibers and wherein the yarn 50 has a larger percentage of the first fibers than the second fibers.

In some implementations, the yarn 110 comprises a twisted combination of one ply of high tenacity PET and nine plies of Sheath-Core PET, the yarn 54 comprises six plies of insulating fiber and two plies of Sheath-Core PET fiber (200 total denier) in a final twist configuration of 40 TPMZ, and the yarn 50 comprises a twisted combination of two plies of high tenacity PET and one ply of Sheath-Core PET.

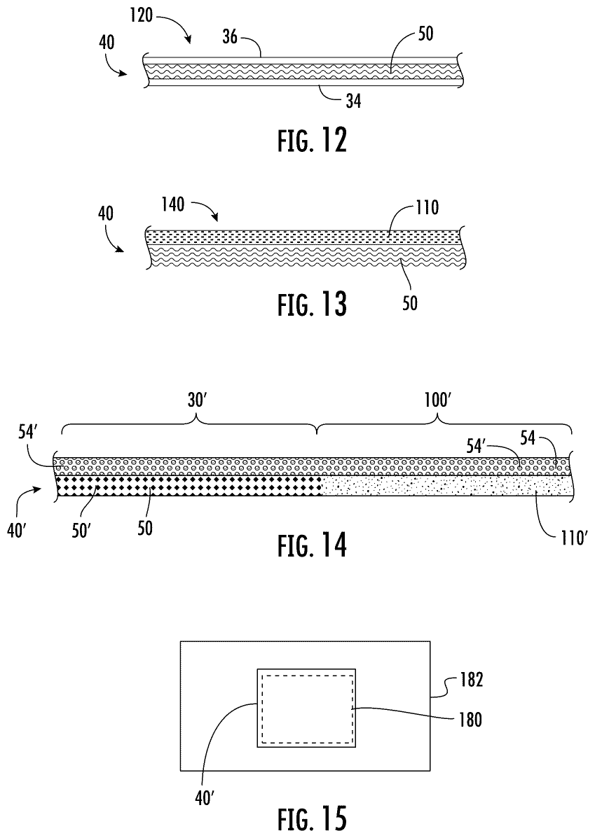

FIG. 12 is a sectional view through an uninsulated portion or zone 120 of garment 20 following treatment or heating. Zone 120 comprises yarn 50 sandwiched between liners 34 and 36. In some implementations, zone 120 may be omitted and replaced with a part of zone 30.

FIG. 13 is a sectional view illustrating portions of an example stay or mounting zone 140. Mounting zone 140 comprises a portion of the seamless volume knitted garment panel 40 comprising yarn 50 and yarn 110. Although not shown, in some implementations, zone 140 may comprise one or both of liners 34, 36 sandwiching panel 40. Yarn 50, upon treatment (heating, melting and/or shrinking) provides tensile strength for zone 140 while the shrunk yarn 110 provides regions of highly condensed polymer material that serve as an embedded rigid region to which other panels or components, such as a stay, may be attached. In the example illustrated, the sleeves of garment 20 are separately formed and attached to the panel or panels forming the front and rear of garment 20, wherein such attachment occurs along zone 140.

FIGS. 14 and 15 illustrate an example method of how panel 40 may be formed. As shown by FIG. 14, a seamless knitted garment panel 40′ is formed by volume knitting, the panel 40′ comprising a first zone 30′ with a first combination of yarns 50′, 54′ and a second zone 100′ having a second combination of yarns 110′ and 54′. In the pretreated state shown in FIG. 9, panel 40′ is substantially flat and smooth across both of zones 30′ and 100′. The thermoplastic polymer fibers of yarns 50′, 54′ and 110′ have not yet been melted or shrunk. Because the thermoplastic polymer fibers of yarn 54′ have not yet been sufficiently heated so as to shrink, the hollow core plastic polymer fibers of yarn 54′ have not yet been crimped and bulked. At such times, the panel 40′ may be joined to other panels or may be joined to such panels after treatment.

As shown by FIG. 15, the seamless knitted garment panel 40′ undergoes treatment which causes the hollow core fibers yarn 54′ to shrink and thereby crimp, curl and bulk, resulting in the now treated yarn 54. The treatment further causes the low melt thermoplastic fibers of yarn 110 to melt and densify in the established state, whereupon cooling, the densified yarn 110 maintains its shape. In the example illustrated, panel 40′ is positioned about a mandrel 180 (shown in broken lines). Mandrel 180 defines the shape of the stiff portion of yarn 110 following treatment. Mandrel 180 serves as a mold for shaping panel 40′ prior to treatment.

In the example illustrated, panel 40′ is treated through the application of heat. In the example illustrated, the mandrel 180 with the shaped panel 40′ is uniformly heated across its entire surface area, such as placing mandrel 180 and the panel 40′ in an oven 182. In other implementations, the exterior surface of mandrel 180 contacting panel 40′ may be heated to heat panel 40′. For example, in some implementations, mandrel 180 may comprise electrically resistive wiring, wherein the supply of electrical current through the wiring generates heat which is conducted through the thermally conductive surface of mandrel 180 to panel 40′. In some implementations, mandrel 180 may include perforations or opening through which heated air is blown to heat panel 40′. Although mandrel 40 is shown as having a rectangular cross-section, panel 40 may have a variety of different shapes and configurations depending upon the final desired shape or profile of the shaped yarn 110.

### Example—Garment 220

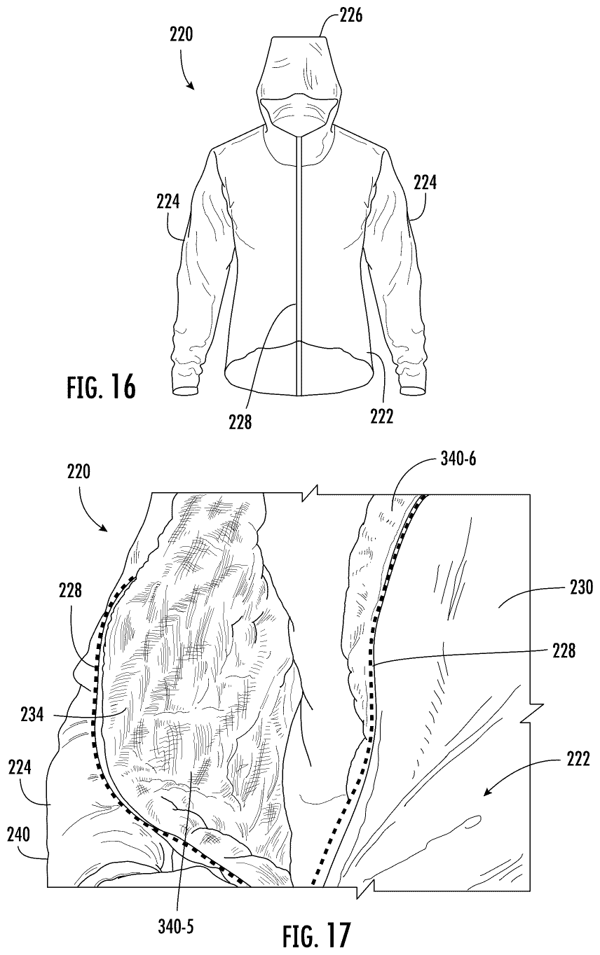

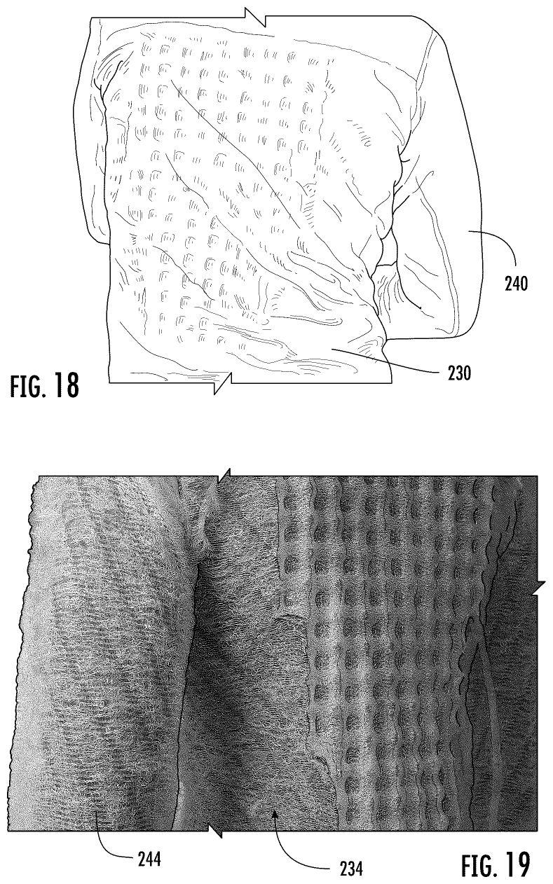

FIGS. 16-18 illustrate an example insulated garment 220 in the form of a jacket. Garment 220 may comprise multiple different regions or zones that exist in the same seamless volume knitted panel or layer. As shown by FIG. 16, garment 220 comprises a torso portion 222 and sleeve portions 224. In some implementations, garment 220 may additionally comprise a hood portion 226.

Torso portion 222 is configured to cover the back and front of the person wearing garment 220, covering the chest and abdomen regions along the front of the person wearing garment 220. In the example illustrated, torso portion 222 is split along its front, having a zipper 228 for selectively opening and closing the front of torso portion 222 of garment 220. In other implementations, torso portion 222 may omit the split, such as with a pullover garment.

Sleeve portions 224 extend from a top of torso portion 222 and are generally tubular in shape, being configured to receive the arms of the person wearing garment 220. In some implementations, sleeve portions 224 may be omitted or may have shorter lengths, such as terminating above elbows of the person wearing garment 220.

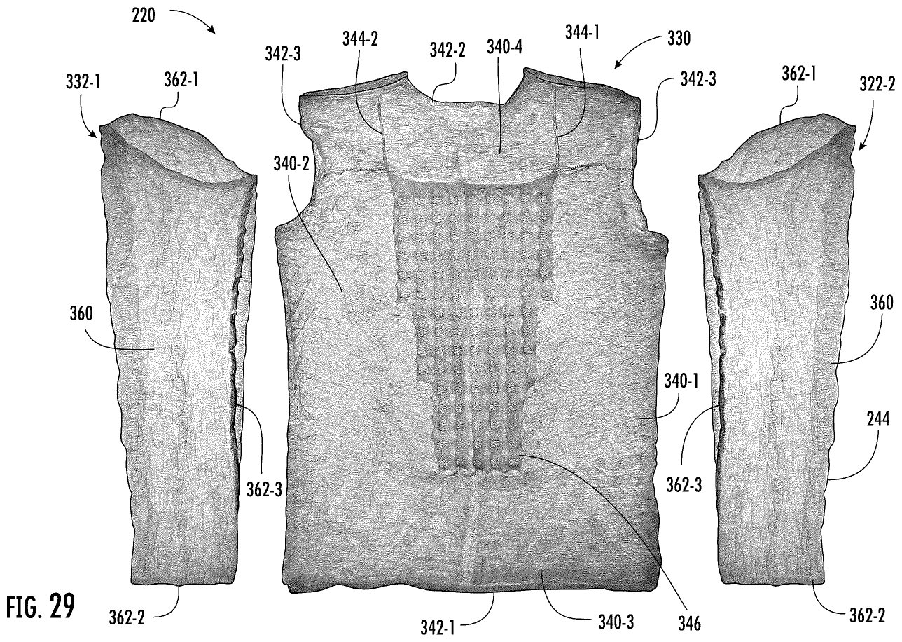

As shown by FIG. 17, torso portion 222 comprises two layers: an exterior layer 230 and an insulation layer 234. Sleeve portions 224 likewise include an exterior layer 240 and an insulation layer 244 (shown in FIG. 29). Exterior layer 230 may be formed from a breathable and water-and-wind resistant material.

FIG. 19 illustrates jacket 220 without exterior layer 230, illustrating insulation layers 234 and 244, which also serve as an internal layer or liner. In other implementations, a separate additional internal layer may be provided. Insulation layer 234 utilizes custom-designed yarns in combination with heat-setting to achieve thermal insulation performance through knitting processes and increase the number of different fabric properties while simultaneously reducing the complexity of the garment construction. Insulation layer 234 uses seamless knit fabric to further reduce assembly complexity while introducing embedded zones with unique mechanical properties that offer novel strategies for improving thermal comfort. The embedded properties also function to reduce the amount of assembly during manufacturing with the ability to automatically transform into multiple pattern shapes, and to reduce the number of layers required by eliminating the need for separate lining and insulation. The strategy also enables embedded modulation of insulation thickness, which can be performed automatically during manufacturing without the addition of seams or assembly complexity. Finally, the materials and knit structures have embedded linear regions with higher stiffness to enable sewn assembly with the other conventional parts of an insulated jacket, such as the outer shell and trim.

Insulation layers 234 and 244 are constructed of 100% Polyethylene Terephthalate (PET) which was selected as the base material because it can be manufactured as a monomaterial, in contrast to typical commercially produced insulation. While a single material is used to produce all functions within the insulation and lining, different properties are achieved through the selection of fibers and the construction of yarns and knit structures. As a result, layers 234 and 244 increase potential recyclability of the garment 220 by using materials that can employ existing consumer waste streams, such as those that process plastic bottles. In other implementations, other materials may be used for one or both of layers 234 and 244.

The insulation layers 234, 244 of garment 20 utilize four yarns composed of a combination of three commercially available fibers. The initial fibers are selected as follows:
50 Denier/12 Filament High-Tenacity PET (Textile Development Associates)
24 Denier/12 Filament Hollow Cross-Section with Fins, 100% PET
30 Denier/12 Filament Sheath-Core Low-melt PET (Shaoxing Global Chemical Fiber Co., Ltd.)

The initial fiber products satisfy a range of constraints. First, industrial knitting requires higher-strength fibers compared to processes for manufacturing nonwovens. At the same time, insulation performance is characterized by taking into account the thermal performance of a material in proportion to its weight; high-performing insulation products are able to demonstrate thermal performance at a very low material weight. As a result, knitted insulation employs higher-strength materials to maintain comparable fabric weights to existing insulation products. 50-Denier and 70-Denier High-Tenacity PET has been selected for its ability to achieve a minimum weight while still demonstrating sufficient tensile strength during the knitting process.

Second, insulation layer 234 uses a commercially available fiber which specifically addresses thermal performance through the ability to trap air molecules within the fibers' small geometric features. Such fibers have a unique cross-section shape which contains both a hollow center/core and eight projecting fins arrayed around its center. Both features increase its thermal performance by introducing additional air inside its hollow area, while trapping air molecules between its fins. As a result, it is been discovered that the use of such fibers are well suited for weft-knit insulation.

Finally, the third fiber used is a 30-Denier Sheath-Core low-melt PET, which consists of a PET core with a low-melt PET sheath, which will melt at a lower temperature than the core material. Its function is to provide thermal bonding between the other materials, which can introduce additional stiffness and loft when the fabric is exposed to heat during its finishing process.

The three base materials are used in different combinations to construct three different yarns, the primary functions of which are to provide thermal insulation, introduce selective stiffness, and enable shape transformation in response to heat.

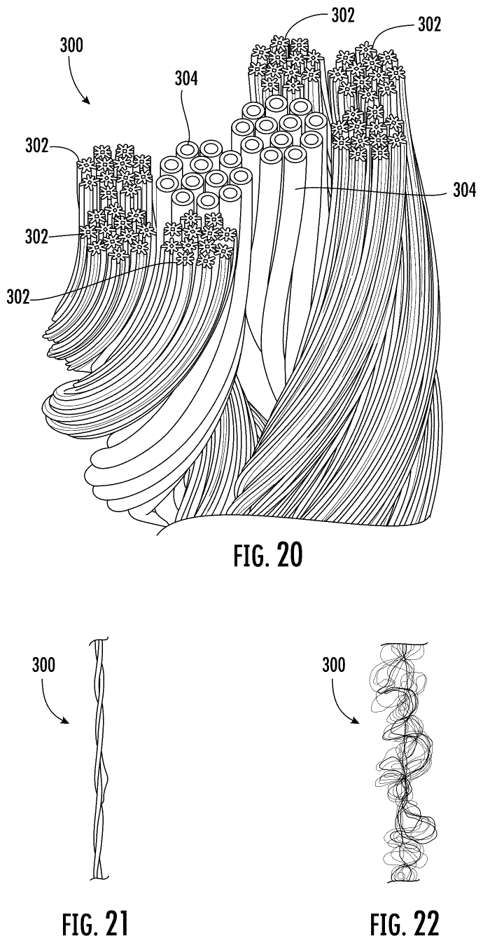

FIGS. 20-22 illustrate an example loft yarn 300. As shown by FIG. 20, insulating fiber plies 302 and the Sheath-Core PET fiber plies 304 are used to create a yarn which primarily functions as thermal insulation. It consists of six total plies of Insulating Fiber and two total plies of Sheath-Core PET fiber (200 total denier) in a final twist configuration of 40 TPM Z the loft yarn 300. The loft is initially compact and smooth as shown in FIG. 21 but transforms into a highly voluminous and textured yarn during a heat-based finishing process as shown in FIG. 22. When the Sheath-Core PET components shrink and bond to the surrounding fibers, crimp and bulk is generated in the insulating fibers of plies 302.

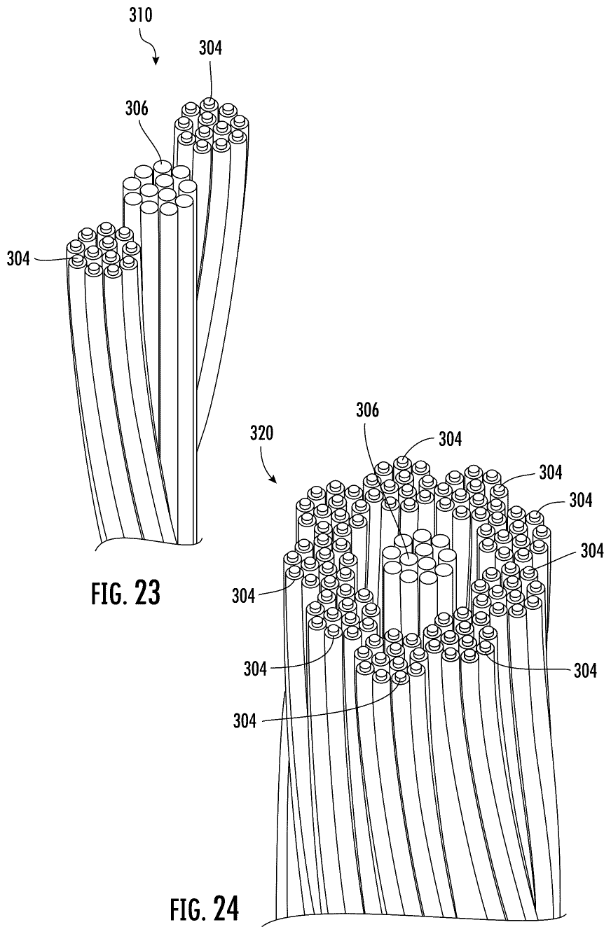

FIG. 23 illustrates an example of a low melt face yarn 310 that is formed by twisting the Sheath-Core PET plies 304 in combination with the High-Tenacity PET plies 306 to produce a 150-Denier/75 TPM-Z yarn. The Low-Melt Face Yarn 310 consists of two total High-Tenacity PET plies 306 and one Sheath-Core PET ply 304. As will be described hereafter, low melt face yarn 310 forms an innermost surface of garment 220, backing the insulation part of the insulation layer 234 and 244 in regions of garment 220 that are to be flexible (not serving as a stay or not thermoformed into a stiffer three-dimensional shape).

FIG. 24 illustrates an example low melt thermoforming yarn 320. Low melt thermoforming yarn 320 consists of nine plies of Sheath-Core PET 304 and one ply of High-Tenacity PET 306, forming a 300-Denier/100 TPM-Z yarn. The larger number Sheath-Core PET plies 304 forming yarn 320 provide a higher level of stiffness as the plies bond or fuse to one another in response to the application of heat. As will be described hereafter, low melt thermoforming yarn 320 is used to form an embedded region that responds to thermoforming during the fabric finishing process.

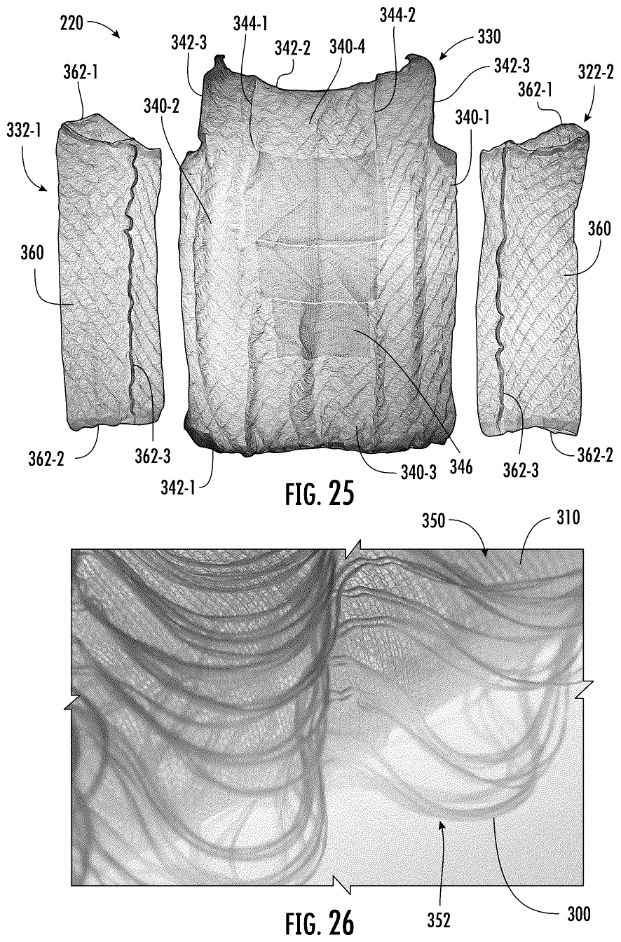

FIG. 25 illustrates example seamless knitted panels 330, and seamless knitted panels 332-1 and 332-2, prior to heat treatment, which are utilized to form insulation layers 234 and 244, respectively, of garment 220. Knitted panel 330 forms a torso portion 222 of garment 220. FIG. 25 illustrates a backside of panel 330 which wraps forwardly around to form a front of torso portion 222, terminating along a split selectively closed by zipper 228. Panel 330 comprises multiple distinct zones of different types of stitches and combinations of yarns.

Panel 330 comprises insulated liner zones 340-1, 340-2, 340-3, and 340-4 (shown in FIG. 25), and insulated liner zones 340-5 and 340-6 (shown in FIG. 17) (collectively referred to as insulated liner zones 340), stay zones 342-1, 342-2 and 342-3 (collectively referred to as stay zones 342), support zones 344-1, 344-2 (collectively referred to as support zones 344), and structural insulation zone 346. Insulated liner zones 340 form a majority of the surface area of panel 330. Insulated liner zones 340-1 and 340-2 extend on opposite sides of structural insulation zone 346 along a backside of garment 220. Insulated liner zones 340-3 and 340-4 extend below and above structural insulation zone 346 along the backside of garment 220. Insulated liner zones 340-5 and 340-6 (shown in FIG. 17) extend from insulated liner zones 340-1 and 340-2, respectively, wrapping around the sides of the torso portion 222 until terminating and joined to portions of zipper 228 or regions of exterior layer 230 along zipper 228.

Insulated liner zones 340 serve as both an interior liner (configured to be closest to and in contact with the person wearing the garment 220 or other clothing articles or on the inside of garment 220) and insulation for garment 220. Insulated liner zones 340 are formed from a seamless knit textile comprising yarns 310 and 300 described above. As shown by FIG. 26, yarns 310 are knit using a tuck stitch to form a liner layer 350 for zones 340. Liner layer 350 is closely knit to inhibit snagging and to provide a soft feel to the liner layer 350. Liner layer 350 creates a smooth surface against the skin, consistent with behavior of a jacket lining. One side liner layer 350 is to face the body of the person wearing garment 220 while the other side faces and backs insulation layer 352 formed by yarns 300.

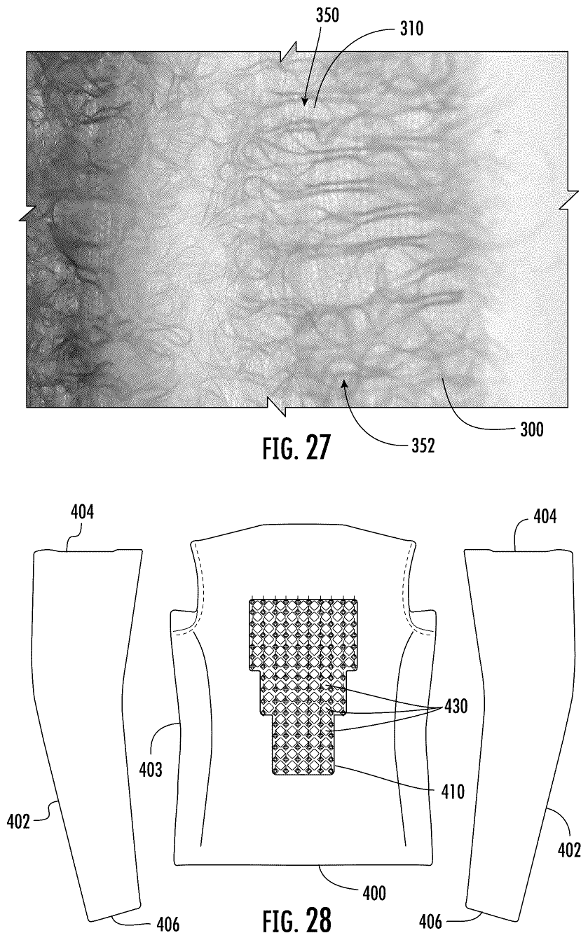

As shown by FIG. 26, yarns 300 are joined to the liner layer 350 by a float stitch, with a majority of such yarns 300 freely floating on one side of liner layer 350. As shown by FIG. 27, although insulation layer 352 formed by yarns 300 is initially flat during and after knitting, the application of a sufficiently high heat (above the melting point of the thermoplastic material forming the exterior of plies 304) for a sufficient amount of time causes the freely floating segments of yarns 300 to shrink horizontally and crimp, creating folds in the fabric face to gain significant bulk, producing a lightweight, fluffy fabric texture with enhanced insulation properties.

In the illustrated example, the low temperature melt thermoplastic fibers employed in yarns 300 and 310 are the same or are compatible. In some implementations, the low temperature melt thermoplastic fibers are formed from polyethylene terephthalate. In some implementations, the hollow core fibers of plies 302 and the high tenacity thermoplastic fibers of plies 306 are all different forms of polyethylene terephthalate. In some implementations, panel 40 exhibits a thermal insulation performance of at least 0.45 clo/100 g.

Stay zones 342 comprise stronger and stiffer regions of panel 330 that may serve as stays, locations where other panels may be joined to panel 330 by stitching or sewing. Stay zone 340-1 extends along the lower edge of panel 330 proximate to the edge of insulation layer 234 of torso portion 222. Stay zone 340-1 provides regions where lower edge portions of exterior layer 230 may be stitched or sewn to panel 330. Similarly, stay zone 342-2 extends along the top edge or neck region of insulation layer 234, providing regions where exterior layer 230 may be joined to upper edge portions of panel 330 by stitching or sewing, and/or regions where hood portion 226 (when provided) may be affixed by stitching or sewing. Stay zones 342-3 are formed about the sleeve openings in panel 330 and provide regions where exterior layer 230 of sleeve portion 224 and/or insulation layers 244 of sleeve portion 224 may be affixed to panel 330 by stitching or sewing.

Each of stay zones 342 is formed by knitting yarn 320 with a tuck stitch. In some implementations, stay zone 342 may be formed from a slight variation of knitting yarn 320, a twist formed from a different ratio of the number of plies 304 to the number of plies 306. The number of plies 304 may be adjusted to adjust the degree of stiffness desired along such stay zones 342. As some flexibility may be desired for such stays (as compared to the stiffer structural insulation zone 346), the number of plies 304 may be reduced. For example, in some implementations, stay zone 342 may be formed from a knit using yarns having eight or fewer plies of pies 304 to a single ply 306. During the treatment, the plies 304 fuse and melt together to form a stiff region for stay zones. Stay zones 342 omit the loft yarn 300.

Support zones 344 provide regions where stronger structural support is provided along panel 330. In the example illustrated, support zones 344 comprise regions that serve as support tethers or support lines extending over shoulder covering portions of panel 330, downward along the back of panel 330 (the side to cover the back of the person wearing garment 220) to an interconnection with an upper end of those yarns forming structural insulation zone 346. Support zones 344 assist in supporting the heavier or denser structural insulation zone 346. In the example illustrated, support zone 344 may have the same construction as stay zones 342. In some implementations, the relative number of plies 304 and 306 for support zone 344 may be adjusted to increase structural strength or increase flexibility.

Structural insulation zone 346 comprises a region of panel 330 that provides both a three-dimensional structural shape and thermal insulation. Structural insulation zone 346 comprises a seamless knit having a structural layer 360 and an insulation layer 362. Structural layer 360 is formed from yarns more susceptible to thermoforming to shape the knit of yarns into a more permanent three-dimensional shape (in contrast to a flat or planar shape) across its surface area. To this end, structural layer 360 is formed from yarns having a larger number of plies 304 or a larger ratio of plies 304 to other plies, wherein plies 304 have groups of filaments having coatings or outer thermoplastic layers that melt and soften to be thermoformed into the three-dimensional shape, whereupon cooling to a temperature below the melting point of such coatings, the groups of filaments retain their thermoformed shape. In the example illustrated, structural layer 360 is formed by yarns 320.

Insulation layer 362 is similar to insulation layer 352 described above except that insulation layer 362 is backed by structural layer 360. As shown by FIG. 37, yarns 300 are joined to the structural layer 360 by a float stitch, with a majority of such yarns 300 freely floating on one side of structural layer 360. Although insulation layer 362 formed by yarns 300 is initially flat during and after knitting, the application of a sufficiently high heat (above the melting point of the thermoplastic material forming the exterior of plies 304) for a sufficient amount of time causes the freely floating segments of yarns 300 to shrink horizontally and crimp, creating folds in the fabric face to gain significant bulk, producing a lightweight, fluffy fabric texture with enhanced insulation properties.

In the illustrated example, the low temperature melt thermoplastic fibers employed in yarns 300 and 310 are the same or are compatible. In some implementations, the low temperature melt thermoplastic fibers are formed from polyethylene terephthalate. In some implementations, the hollow core fibers of plies 302 and the high tenacity thermoplastic fibers of plies 306 are all different forms of polyethylene terephthalate. In some implementations, panel 330 exhibits a thermal insulation performance of at least 0.45 clo/100 g.

Seamless knitted panels 332-1 and 332-2 have opposite edges sewn together to form the tubular shapes shown in FIG. 25. Panels 332 mirror one another and are configured for securement to panel 330 at ends opposite to sleeve openings. Each of panels 332 comprises insulated liner zone 370 and stay zones 372-1, 372-2 and 372-3 (collectively referred to as stay zones 372).

Insulated liner zone 370 extends substantially 360° about the centerline of each of the tubular shapes formed by panels 332, terminating along stay zone 372-3. Each insulated liner zone 370 is substantially similar to insulated liner zone 340 described above. Each insulated liner zone 370 comprises a liner layer 350 and an insulation layer 352 (described above and shown in FIGS. 26 and 27).

Stay zones 372 are structurally similar to stay zones 342 described above. Stay zone 372-1 extends along a top of the tubular structure and serves as a stiffer region for mounting to the sleeve openings of panel 330 forming the torso portion of the garment 220. Stay zone 372-2 extends along a lower perimeter of the tubular structure formed by panel 332 and serves as a stiffer region to which the liner may be stone or otherwise joined. Similarly, stay zone 372-3 extends from stay zone 372-1 to stay zone 372-2 along what is to be the inside surface of the sleeve, providing stiffer regions to which the external layer 240 may be sewn or otherwise affixed.

FIG. 28 illustrates an example of a set of tooling, armatures or mandrels for supporting the three pieces formed by seamless knitted panels 330, and seamless knitted panels 332-1 and 332-2, during heat treatment. FIG. 28 illustrates torso mandrel 400 and sleeve mandrels 402. Mandrels 400 and 402 may be formed from a material or combination of materials having a melting point greater than the temperature applied during thermoforming and having a sufficient structural rigidity to maintain their shape during thermoforming. Torso mandrel 400 is configured to support panel 330 during thermoforming. Torso mandrel 400 performs two functions during thermoforming: (1) defining the overall shape of the final torso portion of garment 220 and (2) facilitating the shaping of structural insulation zone 346. FIG. 29 illustrates panels 330 and 332 following thermoforming on mandrels 400, 402, respectively.

As shown by FIG. 28, mandrel 400 is generally tubular and has a slight hourglass shape 403. Mandrels 402 have an angled and tapering shape, tapering from a top end 404 to a bottom end 406. In other words, the outer diameter of such mandrels 402 (which are tubular in shape) decreases as it goes from end 404 to end 406. During thermoforming, the thermoplastic fibers or plies shrink to an extent defined by the outer surfaces of mandrels 400 and 402. As a result, the insulation layer 234, forming the torso portion 222 of garment 220 also has a generally cylindrical three-dimensional shape with an hourglass shape 370. Insulation layers 244, forming the sleeves 224 of garment 220, have a generally cylindrical three-dimensional shape with a tapering inner diameter that decreases from stay/seam assembly zone 362-1 to stay zone 362-3. In contrast to existing garments where such shaping must be formed by cutting and joining multiple distinct shaped pieces, such three-dimensional shapes are formed by the controlled shrinking that takes place during thermoforming. As result, garment 220 is less complex and the cost and complexity for the manufacture of garment 220 are reduced.

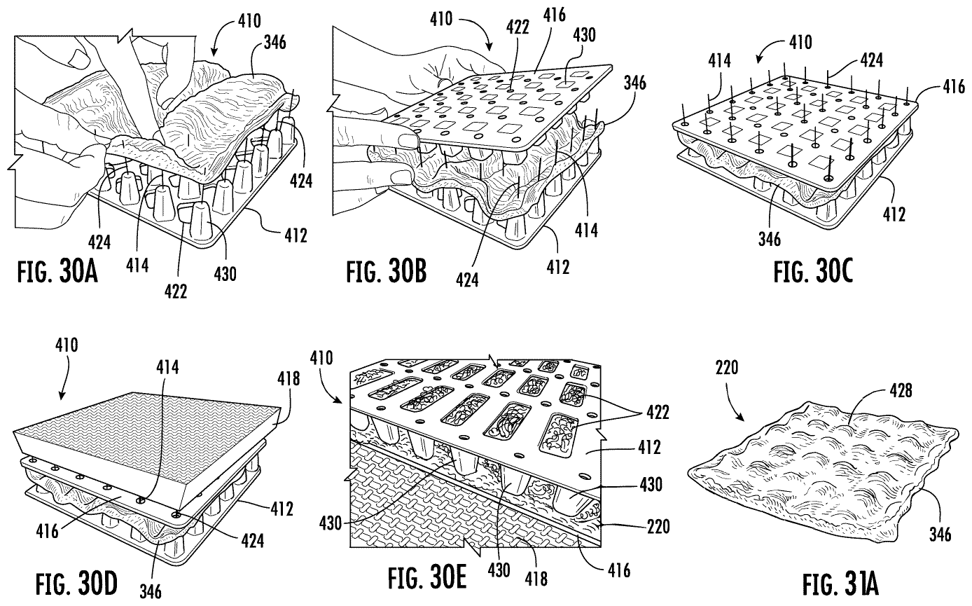

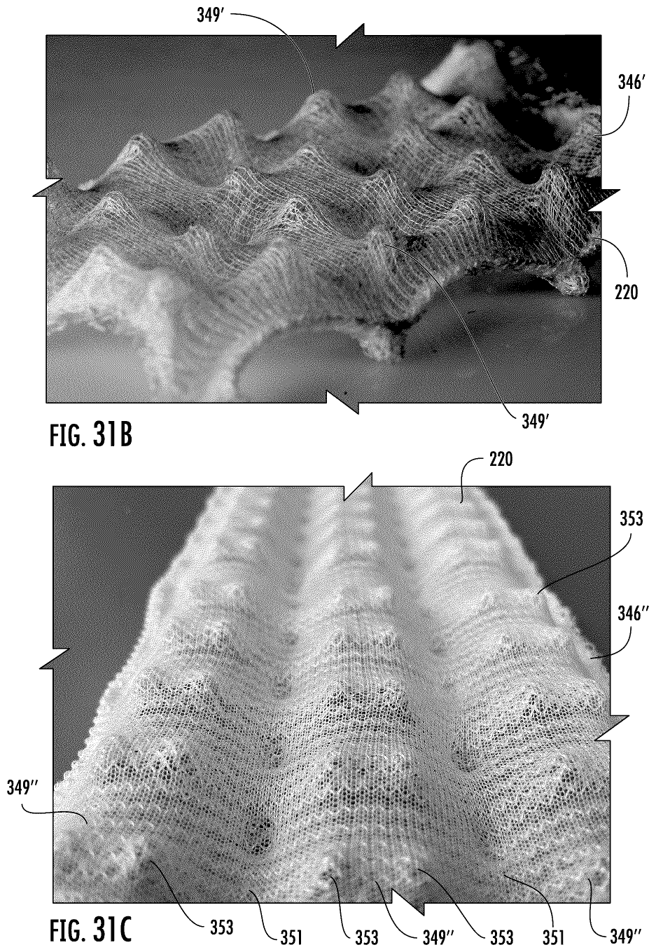

As shown by FIG. 28, mandrel 400 comprises a structural shaping region 410 for shaping structural insulation zone 346. FIGS. 30A-30E illustrate a portion of structural shaping region 410 and how structural shaping region 410 shapes structural insulation zone 346 during thermoforming. FIG. 31A illustrates an example of the textile shaped by the process shown in FIGS. 30A-30E. As shown by such Figures, structural shaping region 410 comprises bottom plate 412, textile grips 414, top plate 416 and retainer 418.

Bottom plate 412 is configured to extend on an inside surface of panel 330. Bottom plate 412 may be contiguous with and integrally formed as part of a single unitary body with remaining portions of mandrel 400. Bottom plate 412 supports textile grips 414 and includes airflow apertures 422. In some implementations, mandrel 400 is hollow, having an opening near a lower end of mandrel 400. In some implementations, mandrel 400 is perforate about its periphery. Apertures 422 as well as the perforated nature of mandrel 400 facilitate air flow through mandrel 400 and through airflow apertures 422. In the example illustrated, panels 330 and 332 undergo thermoforming through the application of convection heating. In some implementations, such convection heating is uniform or global, such as where mandrels 400 and 402, with the supported panels 330 and 332, respectively, are placed in or conveyed through an oven.

In some implementations, rather than global or uniform heating, heated air may be blown are directed at different portions of panels 330, 332. In such implementations, different heat sources may be utilized to direct heated air at different temperatures at different portions of panels 330, 332. By heating different portions of panel 330, 332 to different temperatures, the degree to which the thermoplastic plies/fibers shrink or fuse in different regions of such panels may be differentially controlled. In contrast to conductive heating, convection heating, the application heat through air, permits panels 330 and 332 undergo heat transformation without being compressed by any contacting heated structure. In other implementations, panels 330, 332 may undergo heat transformation using conductive heating or other forms of heating.

Textile grips 414 grip and support structural insulation zone 346 of panel 330 during thermoforming. During thermoforming, the knit textile material of structural insulation zone 346 undergoes shrinking, imposing substantial forces that otherwise tend to flatten structural insulation zone 346. Textile grips 414 hold individual locations of structural insulation zone 346 in place against such forces to shape structural insulation zone 346. In the example illustrated, textile grips 414 comprise pins 424 rising from bottom plate 412 and engaging or passing through the knit textile material of structural insulation zone 346.

Top plate 416 extends opposite the bottom plate 412, sandwiching the textile material of structural insulation zone 346 therebetween. Top plate 416 has openings 420 corresponding to the location of pins 424 to retain an upper end of pins 424 in place during thermoforming. As with bottom plate 412, top plate 416 comprises airflow apertures 422. For further airflow, top plate 416 is supported in a spaced relationship to bottom plate 412 to facilitate airflow in a direction generally parallel to the plains of plates 412 and 416.

Retainer 418 comprises a structure configured to engage pins 424 to assist in retaining plates 412 and 416 against movement as such plates experience large, imposed forces during the shrinking of the knitted textile material of structural insulation zone 346. In the example illustrated, retainer 418 comprises a foam block which removably receives an upper end of such pins 424 and controls the spacing of pins 424.

In the example illustrated, pins 424 are arranged in a grid-like pattern extending not only about the perimeter of the structural insulation zone 346 of panel 330, but also at multiple locations within the perimeter of the structural insulation zone 346. Pins 424 are arranged such that the structural insulation zone 346 is provided with an undulating shape having an array or grid of undulations 428, similar to a waffle, as shown in FIG. 31.

As further shown by such Figures, at least one of plates 412, 416 further comprises bumps or shaped protrusions 430 that extend into the void between plates 412, 416. In the illustrated example, pins 424 (or other textile grips) are supported by and project from protrusions 430. Such shaped protrusions 430 further assist in defining the final three-dimensional shape of the opposing surfaces of the knitted textile material of structural insulation zone 346. In other implementations, such shaped protrusions 430 may be provided on only one inner face of plate 412 or plate 416. In some implementations, such shaped protrusions 430 have other shapes (other than a semi-spherical mound or pillar) or may be omitted. For example, in some implementations, rather than comprising upstanding pillars or posts, protrusions 430 may comprise elongate berm protrusions that extend in linear rows or columns or that extend in a serpentine manner. In such implementations, the pins 424 (or other textile grips) may be intermittently or periodically spaced along and project from the linear serpentine row or column.

FIGS. 30A-30E illustrate just one example of how structural insulation zone 346 may be shaped during thermoforming. For example, pins 424 may have other layouts such that structural insulation zone 346 is held in a different manner, wherein the shrinking of the material causes structural insulation zone 346 to assume a different shape. FIGS. 31B and 31C illustrate other example shapes for structural insulation zone 346 that may be achieved during thermoforming. Though structure zone 346 is illustrated in the context of the jacket 220, structural zone 346 (or the alternative structural zones such as zones 346′ and 346″ described below) may be utilized in any of various textile items. For example, such structural zones may be incorporated into textile items such as backpacks, sleeping bags, purses or any other textile items where airflow, enhanced thickness/spacing, support and/or cushioning may be beneficial.

FIG. 31B illustrates a portion of an example structural insulation zone 346′. Like zone 346, zone 346′ comprises two layers: a structural layer backing and supporting an insulation layer. The two layers of zone 346′ have a composition and knit the same as zone 346. Zone 346′ is shaped in a manner similar to that described above with respect to FIGS. 30A-30E; the only difference being that the mandrel 400 has a different arrangement of textile grippers and protrusions 430 which support the knit textile in a different profile during thermoforming. In contrast to the grid-like orderly arrangement of rows and columns of protruding “islands” or mounds, zone 346′ has more of a random layout of more pointed islands to provide a different support and feel to the textile item including zone 346′.

FIG. 31C illustrates a portion of an example structural insulation zone 346′. Like zone 346, zone 346′ comprises two layers: a structural layer backing and supporting an insulation layer. The two layers of zone 346′ have a composition and knit the same as zone 346. Zone 346′ is shaped in a manner similar to that described above with respect to FIGS. 30A-30E; the only difference being that the mandrel 400 has a different arrangement of textile grippers and protrusions 430 which support the knit textile in a different profile during thermoforming. In contrast to the grid-like orderly arrangement of rows and columns of protruding “islands” or mounds, zone 346′ has more of a random layout of more pointed islands 349′ to provide a different support and feel to the textile item including zone 346′.

FIG. 31C illustrates a portion of an example structural insulation zone 346″. Like zone 346, zone 346″ comprises two layers: a structural layer backing and supporting an insulation layer. The two layers of zone 346″ have a composition and knit the same as zone 346. Zone 346″ is shaped in a manner similar to that described above with respect to FIGS. 30A-30E; the only difference being that the mandrel 400 has a different arrangement of textile grippers and protrusions 430 which support the knit textile in a different profile during thermoforming. In contrast to the grid-like orderly arrangement of rows and columns of protruding “islands” or mounds, zone 346″ comprises a plurality of columns or rows of raised portions (referred to as “berms” 349″) separated by an intervening grooves or valleys 351. In the example illustrated, each of berms 349″ may have a plurality of elevated points or peaks 353 projecting from their tops to provide a level of cushioning, spacing and/or airflow. In other implementations, zone 346 may have other shapes for example, rather than substantially linear berms 346″, such berms 349″ and the corresponding valleys 351 may alternatively extend in a serpentine manner across a face of zone 346.

In other implementations, pins 424 may alternatively project from top plate 416 rather than from bottom plate 412. In other implementations, textile grips 414 may have other configurations. For example, in other implementations, textile grips 414 may comprise hooks, clips or other mechanisms, supported by either or both of plates 412 or 416 and configured to releasably grip or engage the knitted textile material of structural insulation zone 346. Although illustrated as being generally parallel and flat, in some implementations, plates 412 and/or 416 may have non-planar or curved profiles such that the overall shaped structural insulation zone 346 also assumes a curved, rounded or wavy shaped profile. Retainer 418 may also have different configurations for releasably engaging pins 424 or other structures of grips 414, other than the illustrated foam block.

In one implementation, each of panels 330, 332 is manufactured inside-out in a seamless tube containing the front and back jacket lining faces. The knit panels 330, 332 are thermoformed over the template shapes provided by mandrels 400, 402 in an oven at 230° C. Following cooling, the thermoformed panels 330, 332 are removed and assembled with the rest of the garment.

In the example illustrated, the three-pieces shown in FIG. 29 are sewn together to form the insulation layers 234 and 244 shown in FIG. 19. Thereafter, the exterior layer 230 is sewn to insulation layers 234 and 244, being attached along the stay zones 342 and 362 (excluding zone 342-3 and 362-1 where the pieces are joined to one another). Zipper 228 is further secured to a stay zone formed along the split along the front of panel 330.

Although the interior insulation/liner of garment 220 is described as being formed by three separate pieces as shown in FIGS. 25 and 29, utilizing three distinct mandrels 400, 402 as shown in FIG. 28, in other implementations, with larger knitting equipment, the three distinct panels 330 and 332 may alternatively be knit as a single piece, a single seamless knit panel that is to be thermoformed. In such implementations, mandrels 400, 402 may be combined as a single mandrel. In addition, stay zones 342-3 and 362-1 for the joining of the three pieces may be omitted.

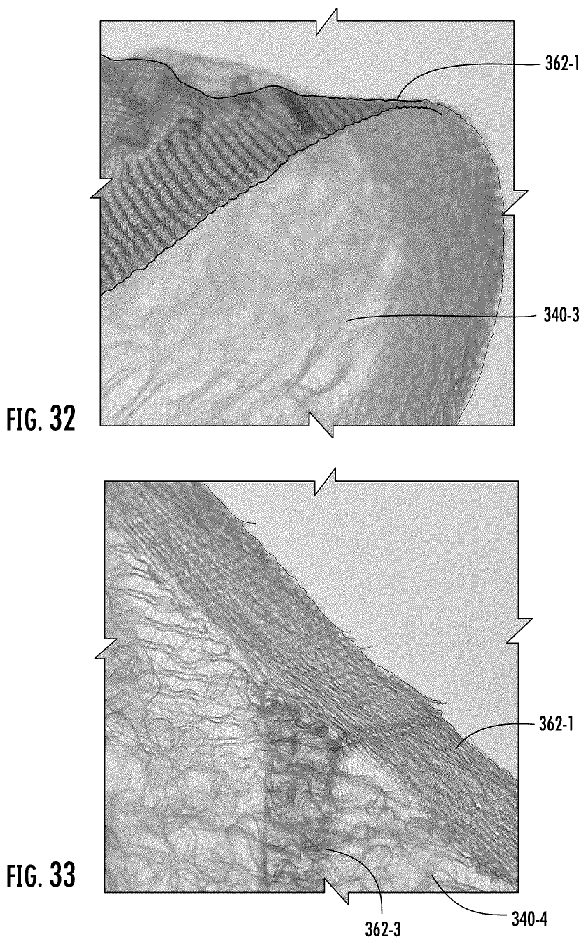

FIGS. 32-38 are enlarged views illustrating portions of panel 330 of garment 220 following thermoforming on mandrel 400. FIG. 32 illustrates stay/seam assembly zone 362-1 along liner portion 340-3. FIG. 33 illustrates seam assembly zone 362-1 from which stay zone 362-3 extends and alongside liner insulation zones 340-4.

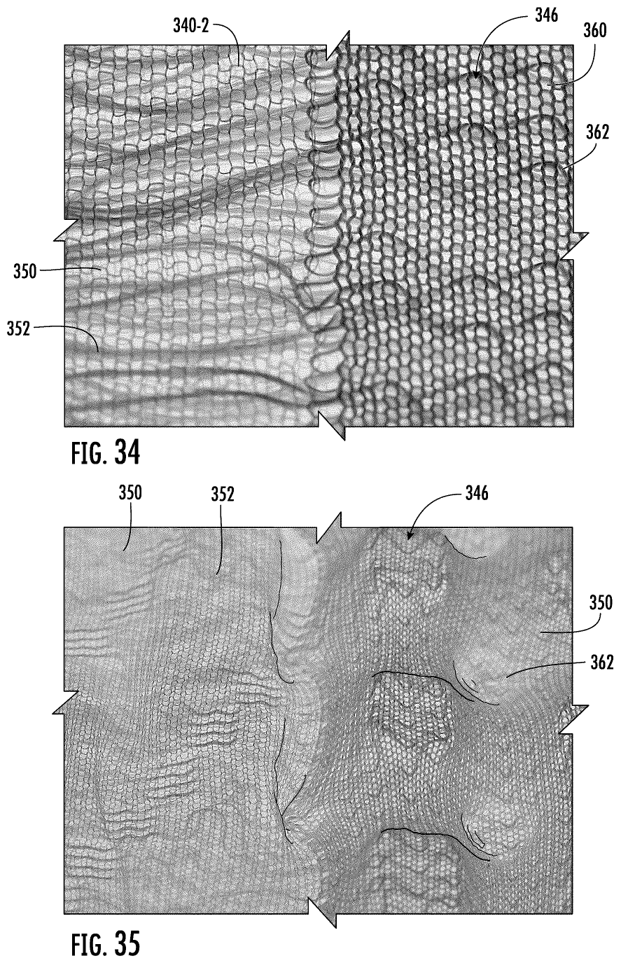

FIG. 34 illustrates the embedded structural insulation zone 346 next to the loft yarn region forming liner insulation zone 340-2 prior to thermoforming. As described above, liner insulation zone 340 comprises liner layer 350 and insulation layer 352 of structural insulation zone 346 comprises liner layer 360 and insulation layer 362 (described above). FIG. 35 illustrates those zones shown in FIG. 34 following thermoforming. As shown by FIG. 35, structural insulation zone 346 has been shaped to provide undulations while the insulation plies or fibers of insulation layer 352 and 362 have been crimped to provide bulk and enhance insulation.

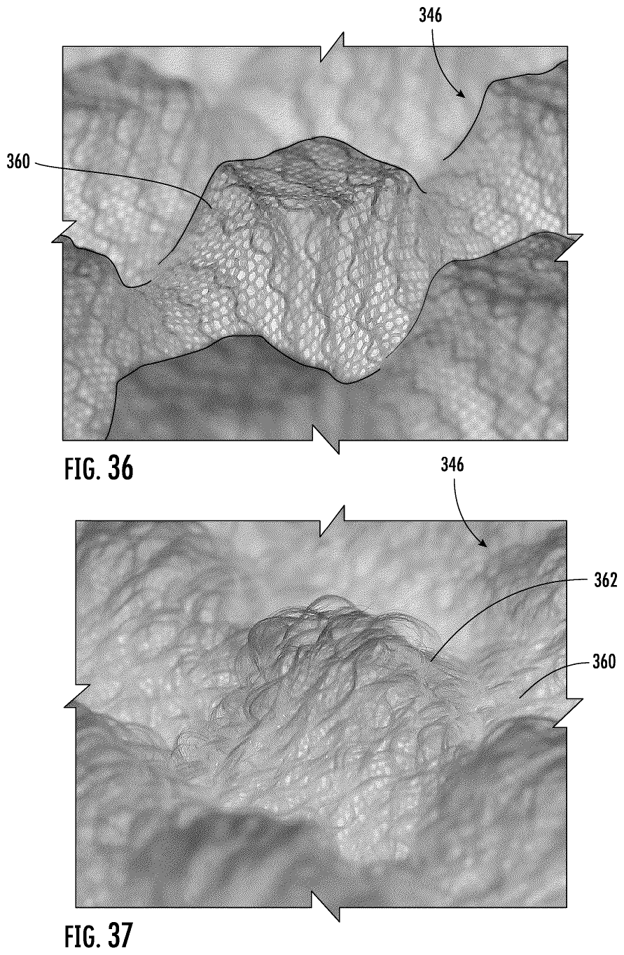

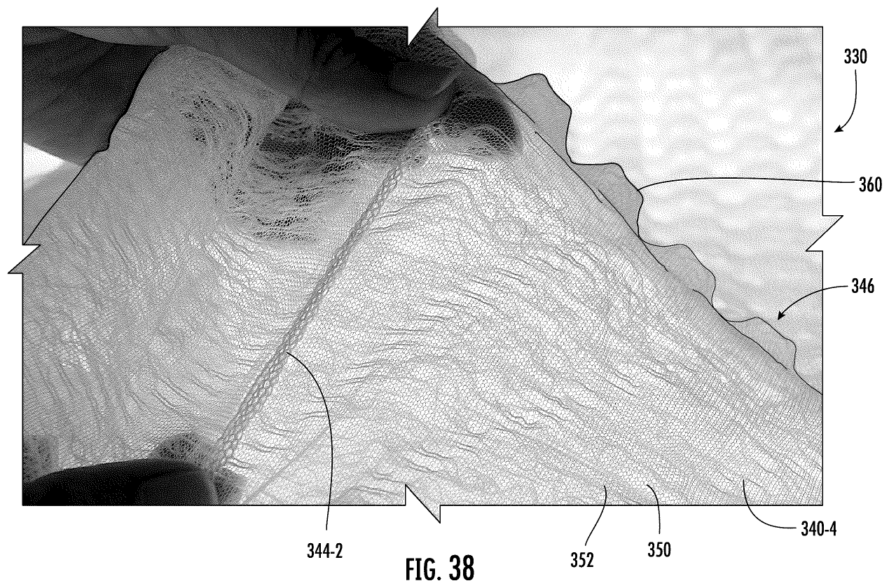

FIGS. 36 and 37 illustrate opposite sides of structural insulation zone 346 following thermoforming. FIG. 36 illustrates a liner side, depicting liner layer 360. FIG. 37 illustrates an insulation side, depicting insulation layer 362. FIG. 38 illustrates the liner side of panel 330 after thermoforming, including liner insulation zone 340-4, support zone 344-2 and structural insulation zone 346.

The thermal performance of insulation zones 340 was evaluated in collaboration with an industry partner (“Measurement of Thermal and Water-Vapour Resistance Under Steady-State Conditions (Sweating Guarded-Hotplate Test” 2014)). Three different samples were produced, each with different amounts of Loft Yarn integrated into the insulation's knit structure. The results were compared to existing commercially available raschel-knit OCTA® 98 gsm Thermofly fabric. The results shown below demonstrate that the knit insulation can achieve thermal performance and warmth-to-weight ratio comparable to Thermofly fabric.

| | CLO Value | | Fabric |
|---|---|---|---|
| Fabric Type | (ISO 11092) | CLO/100 g | Weight (gsm) |
| Thermofly | 0.42 | 0.40 | 98 |
| Loft Yarn Knit V1 | 0.45 | 0.45 | 147 |
| Loft Yarn Knit V2 | 0.66 | 0.66 | 177 |
| Loft Yarn Knit V3 | 0.80 | 0.80 | 206 |

### Example Backpacks 520, 720

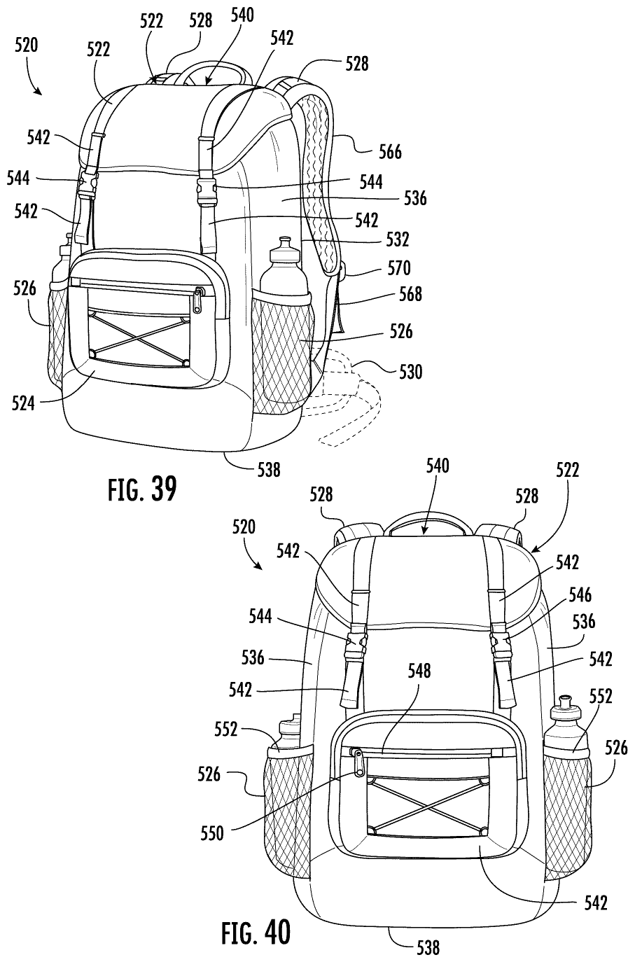

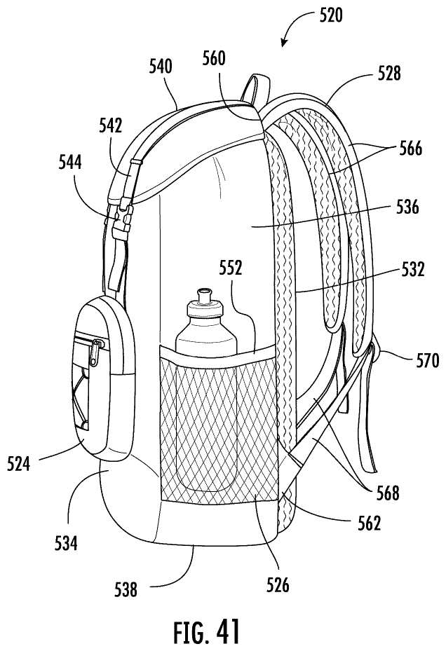

FIGS. 39-41 are perspective views illustrating an example textile item in the form of an example backpack 520. Backpack 520 comprises at least one multi-zone thermoformed seamless knitted textile panel. As a result, backpack 520 may be formed or manufactured from fewer parts and may provide enhanced functionality with lower complexity and cost. Backpack 520 comprises main compartment 522, auxiliary compartment 524, side pouches 526, and shoulder straps 528. As shown by broken lines in FIG. 39, in some implementations, backpack 520 may additionally include an optional waistbelt 530. Although illustrated as a hiking or classroom backpack, in some implementations, backpack 520 may a slightly revised construction so as to serve as a running pack.

Main compartment 522 comprises a textile container providing an interior for containing and carrying items. Main compartment 522 comprises a front 532, the back 534, opposite sides 536, a bottom 538 and a top 540. In some implementations, at least one of front 532, the back 534, opposite sides 536, a bottom 538 and a top 540 comprises a multi-zone thermoformed seamless knitted textile panel. In some implementations, each of front 532, the back 534, opposite sides 536, a bottom 538 and a top 540 are formed from a single multi-zone thermoformed seamless knitted textile panel.

In the illustrated example, main compartment 522 has a top opening serving as an access opening that is bordered by the upper perimeter edges of front 532, back 534, and opposite sides 536, wherein top 540 is in the form of a flap serving as a lid or cover that pivots between a closed position as shown and an open position. The flap may be part of the single multizone thermoformed seamless knitted textile panel. In other implementations, the flap may be a separate piece or panel joined to the single multizone thermoformed seamless knitted textile panel.

Top 540 is releasably secured in the closed position by straps 542 and quick release buckles or fasteners 544. In other implementations, main compartment 522 may alternatively have rear or side facing access openings, wherein the top 540 is not a movable flap, but is part of the same single multizone thermoformed seamless knitted textile panel or comprise a separate panel joined to the same single multizone thermoformed seamless knitted textile panel. Although illustrated as a rectangular prism, in other implementations, main compartment 522 may have other shapes.

Auxiliary compartment 524 is joined to and extends along back 534 of main compartment 522. Auxiliary compartment 524 has an access opening 548 closed by zipper 550. In some implementations, auxiliary compartment 524 may be omitted.

Side pouches 526 extend from sides 536 of main compartment 522. Side pouches 526 have upwardly facing mouth's 552 for the reception of items, such as bottles and the like. In some implementations, one or both of side pouches 526 may be omitted.

Shoulder straps 528 are coupled to main compartment 522, extending forwardly along the front 532 of main compartment 522. Shoulder straps 528 have an upper and 560 coupled to main compartment 522 proximate to top 540 and a lower end 562 coupled to main compartment 522 proximate bottom 538. In the example illustrated, each shoulder strap 528 comprises an upper padded portion 566 and a lower strap 568 having an adjustable length via a buckle 570. Upper padded portion 566 has a length so as to extend over a top of the shoulders of the person wearing backpack 520.

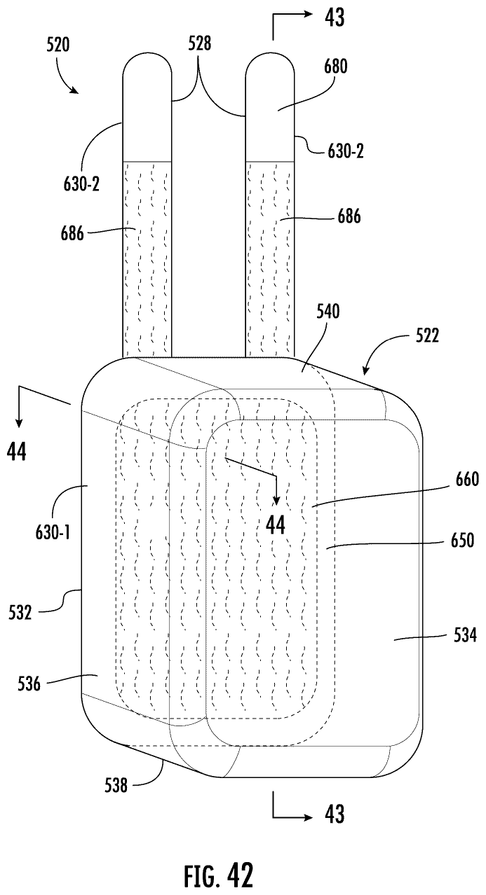

FIGS. 42-44 are simplified schematic representations of selected portions of backpack 520, illustrating an example of how backpack 520 incorporates one or more multi-zone thermoformed seamless knitted textile panels. As shown by such figures, front 532 comprises a single multi-zone thermoformed seamless knitted textile panel 630-1 that comprises a flexible zone 650 and structural zone 660. The different zones 650 and 660 are seamlessly part of a single panel through intarsia. Flexible zone 650 comprises that portion of panel 630-1 that is bendable or flexible. Flexible zone 650 may have a composition similar to that of liner layer 350 described above. Flexible zone 650 may comprise a tuck knit of yarns 310. In some implementations, panel 630-1 additionally forms sides 532, bottom 538, top 540 and/or back 534 of main compartment 522. In some implementations, flexible zone 650 of panel 630-1 further extends rearwardly from front 532 to form sides 536 and potentially back 534 of main compartment 522. In some implementations, flexible zone 650 extends rearwardly from front 532 to form bottom 538 and/or top 540.

Structural zone 660 comprises one or more sections that extend along front 532 to provide enhanced spacing, thickness and/or airflow along front 532 of main compartment 522. Structural zone 660 enhances the stiffness or rigidity of front 532 or enhances the cushioning of front 532. As a result, backpack 520 may be more comfortable to a person wearing backpack 520. In some implementations, structural zone 660 serves as the sole back frame or support for compartment 522. In some implementations, structural zone 660 cooperates with additional polymer or metal frame components to serve as a spine or a stiff back structure for supporting main compartment 522 along the back of the person wearing backpack 520.

Structural zone 660 has a composition similar to structural layer 360 described above. Structural zone 660 may be formed from a tuck knit of yarns 320 which are more susceptible to thermoforming and fusing. Structural zone 660 may have an undulating grid or waffle like inner and outer surface to provide enhanced thickness, and airflow. In other implementations, structural zone 660 may have other patterns or three-dimensional shapes surfaces. For enhanced thickness or deeper undulations, structural zone 660 may alternatively be formed from yarns having a larger ratio of plies 304.

Structural zone 660 may be formed as described above with respect to the forming of structural layer 360. For example, panel 630-1 may be positioned between plates 412 and 416 with textile grips panel 630-1 in zone 660. Panel 630-1 may then be subjected to thermoforming, such as about a mandrel while being placed within or moving through an oven that applies convection heating to the thermoplastic materials of plies 304 of yarn 320, causing such plies to soften or melt and fuse in the targeted and defined shape. Upon cooling, zone 660 retains its shape for bracing front 532 of main compartment 522 and/or for providing a degree of cushioning along front 532 (depending upon the stiffness of the three-dimensional structure formed by the thermoformed structural zone 660).

In the example illustrated, shoulder straps 528 each comprise a multizone thermoformed seamless knitted textile panel 630-2. Panels 630-2 form at least a portion of their respective shoulder straps 528. Each of panels 630-2 comprises a flexible zone 680 and a structural cushioning zone 686. The different zones 680, 686 are seamlessly part of a single panel through intarsia. Flexible zone 680 extends along at least a majority of a length of shoulder strap 528. Flexible zone 680 comprises that portion of panel 630-2 that is bendable or flexible. Flexible zone 680 may have a composition similar to that of liner layer 340 of flexible zone 640 described above. Flexible zone 680 may comprise a tuck knit of yarns 310.

Structural cushioning zone 686 provides a three-dimensional structure backed by a layer of bulk cushioning fibers. Structural cushioning zone 686 is located so as to extend over and across a top of the underlying shoulder of the person wearing backpack 520. Structural cushioning zone 686 may be similar to structural insulation zone 346 described above, wherein structural cushioning zone 686 comprises structural layer 360 (described above) facing the shoulders of the person wearing backpack 520 and insulation layer 362 (described above) which also serves as a cushioning layer. Structural cushioning zone 686 may be formed in a fashion similar to the formation of structural insulation zone 346 as described above with respect to FIGS. 30A-30E.

As should be appreciated, the thickness of the insulation/cushion layer 362 and its ability to cushion the weight of backpack 520 on the shoulder of a person wearing backpack 520 may be controlled by adjusting the length of the yarn forming the floating stitches as well as the composition of the yarns of cushioning layer 362. For example, longer lengths of the yarn forming the float stitch or a higher ratio of plies 302 to plies 304 may increase the insulation/cushioning effect of layer 362. Likewise, the stiffness or rigidity of the three-dimensional surface provided by structural layer 360 may be controlled by controlling the dimension or depth of the undulations during thermoforming as well as controlling the composition of yarns forming structural layer 360. For example, the stiffness or rigidity of structural layer 360 may be increased by increasing the ratio of plies 304 to plies 306 in the yarn or yarns knitted to form layer 360.

In the example illustrated, both of panels 630-1 and 630-2 form a portion of their respective larger components of backpack 520. In particular, additional panels or sheets may be to panel 630-1 and 630-2 to provide enhanced moisture blocking and the like. In the example illustrated, panels 630-2 have an outermost surface covered by outer panel 670.

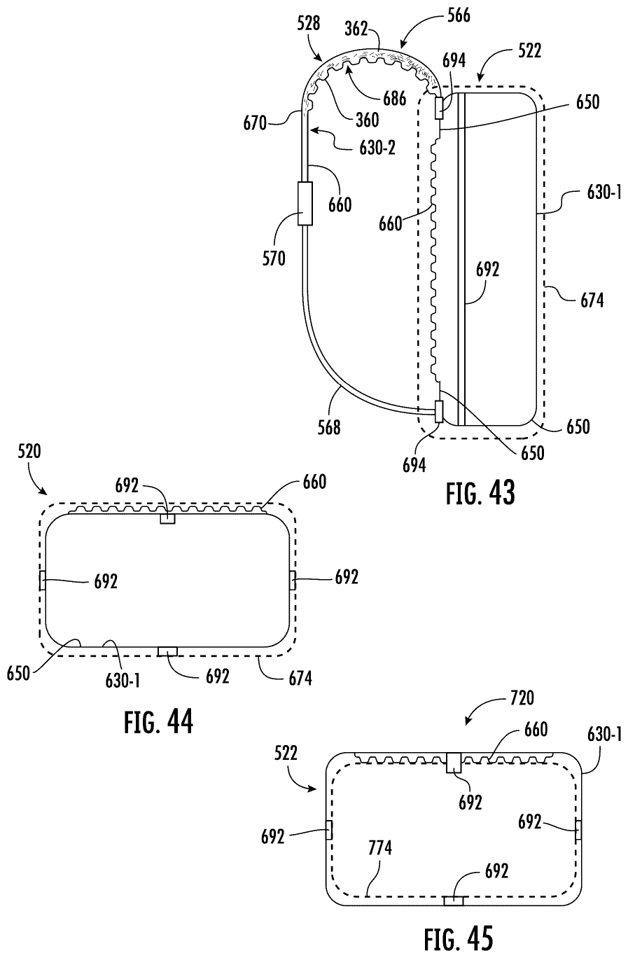

As shown by FIGS. 43 and 44, in implementations where substantially an entirety of the main pack 522 is formed by panel 630-1, the main pack 522 has an outermost surface provided by exterior layer 674 (shown in broken lines) which extends about the outside of panel 630-1. Exterior layer 674 may be impermeable to moisture. Exterior layer 674 may provide enhanced structure or shape to main compartment 522. In some implementations, exterior layer 674 may be omitted.

In the example illustrated, panel 630-1 additionally include stay zones 692 at selected locations. Stay zones 692 are similar to stay zones 342 described above. Stay zones 692 are part of the seamless panel 630-1 through intarsia. Stay zones 692 provide rigid or stiff regions where other structures, such as exterior layer 674, may be stitched or otherwise secured to panel 630-1.

FIG. 45 illustrates an alternative backpack 720. Backpack 720 is similar to backpack 520 except that backpack 720 comprises an interior layer 774 in place of exterior layer 674. Interior layer 774 is joined to panel 630-1 along an interior of the main compartment 522. Interior layer 774 may be moisture impermeable or may have other properties for lining the interior of main compartment 522. Interior layer 774 is stitched and joined to panel 630-1 at locations corresponding to stay zones 680. In some implementations, backpack 720 may omit interior layer 774.

In the example illustrated, backpacks 520 and 720 are illustrated as having distinct multi-zone thermoformed seamless knitted textile panels providing shoulder straps 528 and main compartment 522. In such implementations, shoulder straps 528 are stitched or otherwise secured to main body 522 at additional stay zones 694. Stay zones 694 are similar to stay zones 342 described above. Stay zones 694 are part of the seamless panel 630-1 through intarsia. Stay zones 694 provide rigid or stiff regions where other structures, such as shoulder straps 528, may be sewn or otherwise secured to panel 630-1. In other implementations, panels 630-2 may be omitted where the illustrated panels 630-2 are replaced by additional protruding portions of panel 630-1. In such implementations, exterior layer 670 may be stitched or otherwise joined to the exterior of those portions of panel forming portions of shoulder straps 528, further reducing the number of pieces cut to assemble backpack 520 (or 720).

The panels 630-1 and 630-2 undergo thermoforming in a manner similar described above with respect to the thermoforming of panels 330 and 332 as described above. During such thermoforming, the thermoplastic portions of yarns 300 shrink and fuse to crimp and fluff the non-thermoplastic insulating fibers of such yarns to form the insulation layers of the panels. During such thermal plastic, the thermoplastic portions of yarns 320 melt and fuse to form the stay zones. In regions where shaping is being performed, the melted and fusing yarns 320 are shaped (for example, as described with respect to FIG. 30A-31) to form the structural zones which retain their three-dimensional shape following cooling. In implementations where overall shaping of the main compartment or the shoulder straps is performed, panels 630-1 and/or 630-2 may position about or against a mandrel during thermoforming. For example, panel 630-1 may be shaped so as to have a tapering bottom or lower end.

### Example Sleeping Bag 820

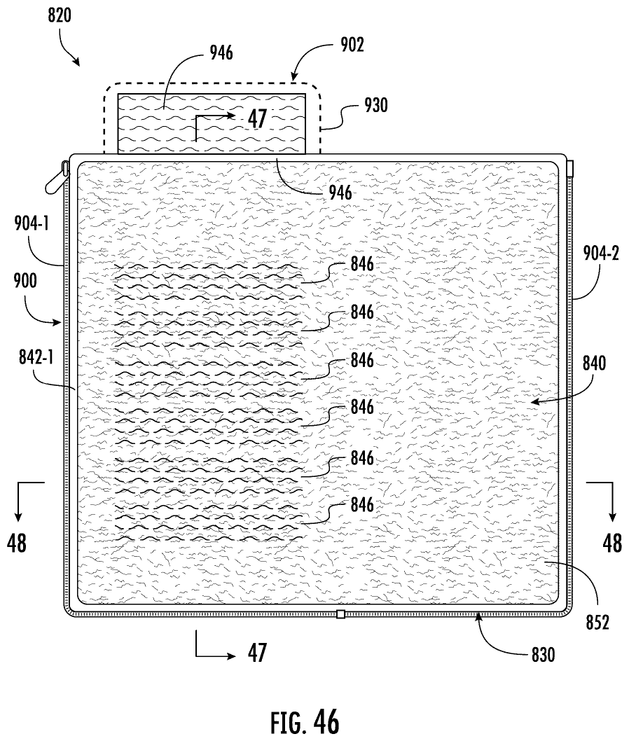

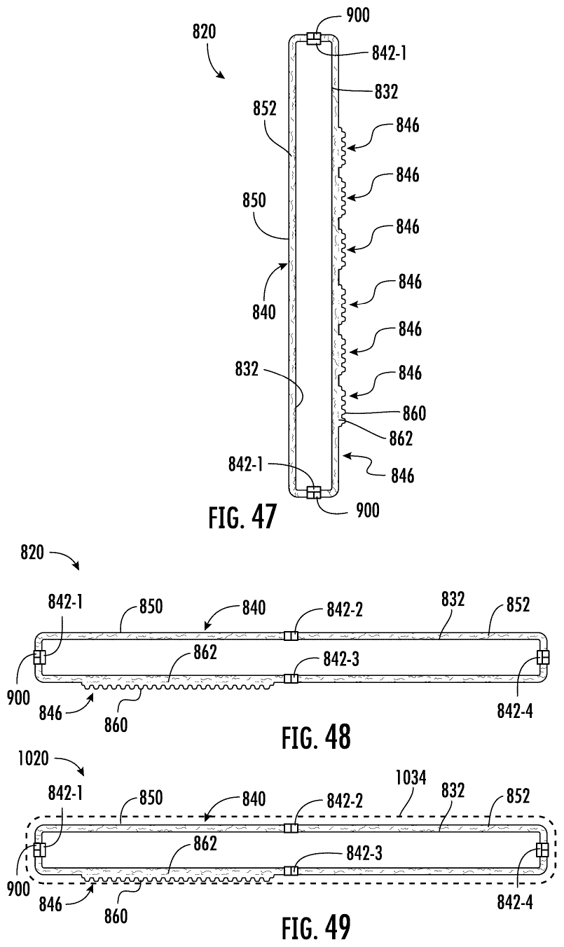

FIGS. 46-48 illustrate portions of an example textile item in the form of an example sleeping bag 820. FIG. 46 illustrates sleeping bag 820 in a fully open state. FIG. 47 is a sectional view of the sleeping bag 820 taken along line 47-47. FIG. 48 is a sectional view of sleeping bag 820 in a closed or folded state (a zipped-up state) and taken along line 48-48. Sleeping bag 820 comprises at least one multi-zone thermoformed seamless knitted textile panel. As a result, sleeping bag 820 may be formed or manufactured from fewer parts and may provide enhanced functionality with lower complexity and cost. Sleeping bag 820 comprises multi-zone thermoformed seamless knitted textile panel 830, inner layer 832 and zipper 900. In some implementations, sleeping bag 820 may additionally comprise a headrest portion 902 (shown in broken lines).

Panel 830 forms the main body of sleeping bag 820 and comprises exterior insulation zone 840, stay zones 842-1, a 42-2, 842-3 and 842-4 (collectively referred to as stay zones 842), and structural insulation zones 846. The different zones 840, 842 and 846 are seamlessly part of a single panel through intarsia. Exterior insulation zone 840 comprises that portion of panel 830 that is bendable or flexible while providing insulation for sleeping bag 820. Exterior insulation zone 840 covers or forms a majority of the overall surface area of sleeping bag 820. Exterior insulation zone 840 may have a composition similar to that of liner insulation zone 340 described above having an exterior layer 850 similar to liner layer 350 described above and an inner insulation layer 852 similar to insulation layer 352 described above. Exterior insulation zone 840 may comprise a tuck knit of yarns 310 to form exterior layer 850 of zone 840 and a floating knit of yarns 300 to form insulation layer 852 of zone 840. Exterior layer 850 extends along an outside of sleeping bag 821 when sleeping bag is closed or folded over and zipped. The degree of insulation provided by insulation layer 852 of zone 840 may be adjusted by controlling the length of those portions of the yarns of the floating knit and/or the composition of such yarns. For example, longer lengths of the yarn forming the float stitch or a higher ratio of plies 302 to plies 304 may increase the insulation rating of layer 852.

Stay zones 842 are each similar to stay zone 342 described above. Each of stay zones 842 may comprise a knit of yarns 320 seamlessly part of panel 830 by intarsia. Stay zone 842-1 extends along and forms a perimeter of panel 830. Stay zone 842 provides a rigid or stiff region to which other structures may be sewn or otherwise attached to panel 830. In the example illustrated, stay zone 842 serves as a region of panel 830 where zipper 900 is sewn to the perimeter of panel 830. Zipper 900 comprises two cooperating portions 904-1, 904-2 extending along three sides of panel 830 such that when panel 830 is folded to overlap itself, the reports 904-1 and 904-2 may be zipped into a closed state. Stay zones 842-2, 842-3 and 842-4 serve as regions of panel 830 where inner layer 832 may be secured to panel 830 by stitching or other attachment mechanisms.

Structural insulation zones 846 comprises one or more sections that extend along a bottom face of a closed sleeping bag 820 and provide enhanced spacing, thickness and/or airflow along back the bottom of sleeping bag 820. Structural zones 846 may provide enhanced rigidity or enhanced cushioning along the bottom of the closed sleeping bag 820 (depending upon the stiffness or rigidity of the three-dimensional structures of structural zones 846). In the example illustrated, structure zones 846 comprise elongate individual zones spaced apart in a column along the longer longitudinal length of sleeping bag 820 (when closed). In the example illustrated, the spacing of such zones and the width of such zones (in the longitudinal direction) facilitates the rolling up of panel 830 (and of sleeping bag 820) in the longitudinal direction around a transverse axis for compact storage and transport of sleeping bag 820. In other implementations, zones 846 may have other configurations or other numbers of zones 846. In other implementations, the multiple zones 846 may be consolidated into a single zone 846 or a fewer number of such zones 846.

Each of zones 846 has a composition similar to structural insulation zone 346 described above. Structural zone 846 may be formed from a tuck knit of yarns 320 which are more susceptible to thermoforming and fusing to form a structural layer 860 which faces outwardly. Structural layer 860 may have an undulating grid or waffle like inner and outer surface to provide enhanced thickness, airflow and support or cushioning. In other implementations, structural layer 860 may have other patterns or three-dimensional shapes surfaces. For enhanced thickness or deeper undulations, structural layer 860 may alternatively be formed from yarns having a larger ratio of plies 304.

Structural insulation zone 846 may be formed from a floating knit of yarns 300 to form insulation layer 862, backed by structural layer 860. Insulation layer 862 faces inwardly and is sandwiched between structural layer 860 and inner layer 832. The degree of thermal insulation provided insulation 862 are different regions of insulation layer 862 may be varied by controlling the length of the yarns that are floating and/or by controlling the ratio of plies 302 to plies 304 in yarn 300.

Structural insulation zones 846 may be formed as described above with respect to the forming of structural insulation layer 346 described above. For example, portions of panel 830 may be positioned between plates 412 and 416 with textile grips gripping panel 830 in zones 846. Panel 830 may then be subjected to thermoforming, such as about a mandrel while being placed within or moving through an oven that applies convection heating to the thermoplastic materials of plies 304 of yarn 320, causing such plies to soften or melt and fuse in the targeted and defined shape. Upon cooling, zones 846 retain their shape for supporting the bottom of sleeping bag 820 above the underlying ground and/or for providing a degree of cushioning along the bottom of sleeping bag 820 (depending upon the stiffness of the three-dimensional structure formed by the thermoformed structural insulation zones 846).

Internal layer 832 comprises one or more panels joined to panel 830 at stays 842 along an inside of the bag 820. Internal layer 832 may be formed from a textile or other material providing a soft liner for the inside of sleeping bag 820. In some implementations, rather than comprising a separate panel or textile joined to panel 830 at stays 842, internal layer 832 may be knit as part of panel 830. For example, liner layer 832 may comprise a knit of yarns having a construction similar to flexible layer 850, wherein the knit yarns 310 of liner layer 832 and the knit yarns of liner layer 850 in flexible zone 840 or the knit yarns of structural layer 860 of structural insulation zones 846 are joined by intarsia and sandwich the knit fibers of insulation layers 852 and 862 therebetween.

FIG. 49 illustrates an example sleeping bag 1020. Sleeping bag 1020 is similar to sleeping bag 820 described above except that sleeping bag 1020 additionally comprises outer cover layer 1034 (shown in broken lines) outer cover layer 1034 extends along the exterior of panel 830 (the outside of sleeping bag 820 in a closed state). Outer cover layer 1034 may be secured or stitched to panel 830 at stays 842. Outer cover layer 1034 may be water impermeable or hydrophobic. Outer cover layer 1034 may have other selected properties for the outermost surface of sleeping bag 1020.

In the example illustrated, both sleeping bags 820 and 920 have structural insulation zones 846 with the structural layer 860 projecting outwardly away from the interior of the sleeping bags when in a closed state. In other implementations, panel 830 may in effect be turned inside out such that structural layer 862 of structural insulation zones 846 project towards the interior of sleeping bag 820 (when in a closed state) with the insulation layers 852 and 862 on the outer side of panel 830. In such implementations, outer cover layer 1030 is joined at stays 842 and covers the insulation layers 862 of panel 830.

In some implementations, rather than comprising a separate panel or textile joined to panel 830 at stays 842, external cover layer 1034 may be knit as part of panel 830. For example, external cover layer 1034 may comprise a knit of yarns having a construction similar to flexible layer 850, wherein the knit yarns 310 of cover layer 1034 and the knit yarns of liner layer 850 in flexible zone 840 or the knit yarns of structural layer 860 of structural insulation zones 846 are joined by intarsia and sandwich the knit fibers of insulation layers 852 and 862.

In some implementations, sleeping bags 820 and 1020 may additionally comprise a headrest portion 902. Headrest portion 902 may comprise a panel 930 joined to panel 830 along a stay 946 of panel 830 and having a structural insulation zone 946 having construction similar to structural insulation zone 846. In some implementations in lieu of being attached at stay 946, panel 930 may alternatively be replaced by a protruding portion of panel 830 having the same liner insulation zone 940. Additional panels inner and/or outer may be secured to panel 930 at stay zones provided on panel 930. In some implementations, headrest portion 902 may be omitted.

The panels 830 (and 930 in some implementations) undergo thermoforming in a manner similar to that described above with respect to the thermoforming of panels 330 and 332 as described above. During such thermoforming, the thermoplastic portions of yarns 300 shrink and fuse to crimp and fluff the non-thermoplastic insulating fibers of such yarns to form the insulation layers of the panels. During such thermal plastic, the thermoplastic portions of yarns 320 melt and fuse to form the stay zones. In regions where shaping is being performed, the melted and fusing yarns 320 are shaped (for example, as described with respect to FIG. 30A-31) to form the structural insulation zones which retain their three-dimensional shape following cooling. In implementations where overall shaping of the sleeping bag is performed, panel 830 may position about a mandrel during thermoforming. For example, panel 830 may be shaped so as to have a tapering bottom or lower end (opposite to the end omitting a zipper).

Although the claims of the present disclosure are generally directed to a multi-zone thermoformed seamless knitted textile panel for use in multiple different types of textile items such as garments, backpacks, sleeping bags, towels, blankets and bed linens, the present disclosure is additionally directed to the features set forth in the following definitions.
1. A garment comprising:
   a seamless knitted garment layer comprising:
      a knitted flexible insulation zone comprising crimped and bulked fibers; and
      a knitted rigidly shaped zone comprising rigid shaped fibers.
2. The garment of Definition 1, wherein the knitted rigidly shaped zone comprises crimped and bulked fibers supported by the rigid shaped fibers.
3. The garment of Definition 2, wherein the garment layer comprises a fabric face and an outer face, wherein the fabric face of the knitted rigidly shaped zone comprises a first yarn, wherein the outer face of the knitted rigidly shaped zone comprises a second yarn, wherein the fabric face of the knitted flexible insulation zone comprises a third yarn and wherein the outer face of the knitted flexible insulation zone comprises the second yarn.
4. The garment of Definition 3, wherein the first yarn has a first degree of stiffness, the first yarn having a first extent of crimped and bulked fibers, wherein the second yarn has a second degree of stiffness less than the first degree of stiffness, the second yarn having a second extent of crimped and bulked fibers greater than the first extent of crimped involved fibers, and wherein the third yarn has a third degree of stiffness less than the first degree of stiffness and greater than the second degree of stiffness, the third yarn having a third extent of crimped and bulked fibers less than the second extent of crimped involved fibers.
5. The garment of Definition 4, wherein the first yarn, the second yarn and the third yarn are all formed from a single material.
6. The garment of Definition 5, wherein the single material is a thermoplastic polymer.
7. The garment of Definition 6, wherein the thermoplastic polymer is polyethylene terephthalate.
8. The garment of Definition 7, wherein the first yarn is configured to enable shaped transformation in response to heat.
9. The garment of Definition 7, wherein the second yarn comprises fibers having hollow centers and fibers that shrink and bond in response to heat.
10. The garment of Definition 7, wherein the first yarn and the third yarn each comprise a first fiber having a first tensile strength and a first melting temperature and a second fiber having a second tensile strength less than the first tensile strength and a second melting temperature less than the first melting temperature, wherein the first yarn has a larger percentage of the second fibers than the first fibers and wherein the third yarn has a larger percentage of the first fibers than the second fibers.
11. The garment of Definition 3, wherein the first yarn is configured to enable shaped transformation in response to heat.
12. The garment of Definition 3, wherein the second yarn comprises first fibers having hollow centers and second fibers that shrink and bond in response to heat.
13. The garment of Definition 12, wherein the first yarn and the second yarn each comprise the second fibers and wherein the first yarn and the third yarn each omit the first fibers.
14. The garment of Definition 13, wherein the first fibers comprise 24 Denier/12 filament hollow cross-section with fins, 100 percent polyethylene terephthalate.
15. The garment of Definition 13, wherein the second fibers comprise 30 Denier/12 filament Sheath-Core low melt polyethylene terephthalate.
16. The garment of Definition 13, wherein prizes third fibers comprising 50 denier/12 filament high tenacity polyethylene terephthalate.
17. The garment of Definition 3, wherein the first yarn and the second yarn each comprise a first fiber having a first tensile strength and a first melting temperature and a second fiber having a second tensile strength less than the first tensile strength and a second melting temperature less than the first melting temperature, wherein the first yarn has a larger percentage of the second fibers than the first fibers and wherein the second yarn has a larger percentage of the first fibers than the second fibers.
18. The garment of Definition 3, wherein the first yarn comprises a twisted combination of one ply of high tenacity PET and nine plies of Sheath-Core PET, wherein the second yarn comprises six plies of insulating fiber and two plies of Sheath-Core PET fiber (200 total denier) in a final twist configuration of 40 TPMZ, and wherein the third yarn comprises a twisted combination of two plies of high tenacity PET and one ply of Sheath-Core PET.
19. The garment of Definition 3, wherein the garment layer comprises embedded stiffness regions formed from shrunk portions of the third yarn and omitting the first yarn and the second yarn.
20. The garment of Definition 3, wherein the knitted rigidly shaped zone is thermoformed.
21. The garment of Definition 3, wherein the knitted rigidly shaped zone extends along a portion of the garment to cover a back of a person wearing the garment.
22. An insulation panel for a garment, the insulation panel comprising:
   a volume knitted panel having an outer face and a fabric face,
   the fabric face comprising a first yarn comprising a twist of a combination of a first number of high tenacity thermoplastic fibers and a second smaller number of low temperature melt thermoplastic fibers,
   the outer face comprising a second yarn comprising a twist of a combination number of fibers having hollow cores and a second smaller number of the low temperature melt thermoplastic fibers.
23. The insulation panel of Definition 22, wherein the second yarn is heat actuatable to a crimped bulked state.
24. The insulation panel of Definition 22, wherein the second yarn, when in a crimped and bulked state has a clo value of at least 0.45/100 g.
25. The insulation panel of Definition 22, wherein the second yarn, when in a crimped and bulked state has a clo value of at least 0.66/100 g.
26. The insulation panel of Definition 22, wherein the second yarn, when in a crimped and bulked state has a clo value of at least 0.80/100 g.
27. A rigid shaped panel for a garment, the rigid shaped panel comprising:
   a volume knitted panel having an outer face and a fabric face,
   the outer face comprising a first yarn comprising a twist of a combination of a first number of fibers having a hollow core and a second smaller number low temperature melt thermoplastic fibers,
   the fabric face comprising a second yarn comprising a twist of a combination of a first number of the high tenacity fibers and a second larger number of the low temperature melt thermoplastic fibers.
28. A method for forming a garment, the method comprising:
   volume knitting a seamless knitted garment layer comprising a first zone with a first combination of yarns and a second zone having a second combination of yarns; and
   treating the seamless knitted garment layer to cause the first zone to undergo crimping and bulking for insulation and to cause the second zone to undergo thermoforming into a rigid three-dimensional shape.
29. The method of Definition 28, wherein the treating comprises uniformly applying heat to the first zone and the second zone.
30. The method of Definition 28, wherein the treating comprises shaping the second zone during application of heat to the second zone.
31. The method of Definition 28, wherein the first combination of yarns comprises first yarns having hollow cores and second heat shrinkable yarns and wherein treating comprises applying an amount of heat to cause the second heat shrinkable yarns to shrink and so as to cause the first yarns to crimp and bulk.
32. A garment comprising:
   a seamless knitted insulated liner comprising:
      a first thickness of crimped and bulked fibers; and
      a second thickness of uncrimped fibers supporting the crimped and bulked fibers and forming a garment inner liner surface.
33. The garment of Definition 32, wherein the crimped and bulked fibers and the uncrimped fibers are all formed from a knit of polyethylene terephthalate (PET) yarns.
34. A backpack comprising:
   a main compartment comprising a multi-zone thermoformed seamless knitted textile panel, the panel comprising:
      a flexible zone; and
      a three-dimensional structural zone proximate an interior of the main compartment.
35. The backpack of Definition 34, wherein the panel comprises extensions forming shoulder straps, wherein the extensions of the panel each comprise a flexible zone and a three-dimensional structural zone.
36. A backpack comprising:
   a main compartment;
   shoulder straps extending from the main compartment, each of the shoulder straps comprising a multi-zone thermoformed seamless knitted textile panel, each panel comprising:
      a flexible zone; and
      a three-dimensional structural zone.
37. A backpack comprising:
   a multi-zone thermoformed seamless knitted textile panel forming at least a portion of a main compartment and at least portions of shoulder straps, the panel comprising:
      at least two of a structural layer, a structural insulation layer, a flexible layer, a liner layer and a stay zone.
38. A sleeping bag comprising:
   a multi-zone thermoformed seamless knitted textile panel, the panel comprising:
      a structural insulation zone; and
      an exterior liner insulation zone.
39. A method for forming a textile item, the method comprising:
   knitting a combination of different yarns as a single seamless textile panel such that the single seamless textile panel comprises a structural layer and a stay zone;
   heating the single seamless textile panel to a temperature to facilitate three-dimensional shaping of the structural layer while at the temperature and to fuse particular yarns of the stay zone to form a stay in the stay zone.
40. The method of Definition 39 further comprising shaping the panel against a mandrel during the heating.
41. A method for forming a textile item, the method comprising:
   knitting a combination of different yarns as a single seamless textile panel such that the single seamless textile panel comprises a structural insulation zone having a structural layer supporting an insulation layer and a liner insulation zone having a liner layer supporting the insulation layer;
   heating the single seamless textile panel to a temperature to facilitate three-dimensional shaping of the structural layer while at the temperature and to shrink particular yarns of the liner insulation layer to bend and crimp loft yarns of the liner insulation layer.
42. The method of Definition 41 further comprising shaping the panel against a mandrel during the heating.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A multi-zone thermoformed seamless knitted textile panel comprising:
a knitted flexible insulation zone comprising crimped and bulked fibers; and
a knitted shaped zone comprising a shaped three-dimensional structural layer.

2. The panel of claim 1, wherein the knitted shaped zone comprises crimped and bulked fibers supported by the shaped three-dimensional structural layer.

3. The panel of claim 2, wherein the panel comprises a fabric face and an outer face, wherein the fabric face of the knitted shaped zone comprises a first yarn, wherein the outer face of the knitted shaped zone comprises a second yarn, wherein the fabric face of the knitted flexible insulation zone comprises a third yarn and wherein the outer face of the knitted flexible insulation zone comprises the second yarn.

4. The panel of claim 3, wherein the first yarn has a first degree of stiffness, the first yarn having a first extent of crimped and bulked fibers, wherein the second yarn has a second degree of stiffness less than the first degree of stiffness, the second yarn having a second extent of crimped and bulked fibers greater than the first extent of crimped involved fibers, and wherein the third yarn has a third degree of stiffness less than the first degree of stiffness and greater than the second degree of stiffness, the third yarn having a third extent of crimped and bulked fibers less than the second extent of crimped involved fibers.

5. The panel of claim 4, wherein the first yarn, the second yarn and the third yarn are all formed from a single material.

6. The panel of claim 5, wherein the single material is a thermoplastic polymer.

7. The panel of claim 6, wherein the thermoplastic polymer is polyethylene terephthalate.

8. The panel of claim 7, wherein the first yarn is configured to enable shaped transformation in response to heat.

9. The panel of claim 7, wherein the second yarn comprises fibers having hollow centers and fibers that shrink and bond in response to heat.

10. The panel of claim 7, wherein the first yarn and the third yarn each comprise a first fiber having a first tensile strength and a first melting temperature and a second fiber having a second tensile strength less than the first tensile strength and a second melting temperature less than the first melting temperature, wherein the first yarn has a larger percentage of the second fibers than the first fibers and wherein the third yarn has a larger percentage of the first fibers than the second fibers.

11. The panel of claim 3, wherein the first yarn is configured to enable shaped transformation in response to heat.

12. The panel of claim 3, wherein the second yarn comprises first fibers having hollow centers and second fibers that shrink and bond in response to heat.

13. The panel of claim 12, wherein the first yarn and the second yarn each comprise the second fibers and wherein the first yarn and the third yarn each omit the first fibers.

14. The panel of claim 13, wherein the first fibers comprise 24 Denier/12 filament hollow cross-section with fins, 100 percent polyethylene terephthalate.

15. The panel of claim 13, wherein the second fibers comprise 30 Denier/12 filament Sheath-Core low melt polyethylene terephthalate.

16. The panel of claim 13, wherein prizes third fibers comprising 50 denier/12 filament high tenacity polyethylene terephthalate.

17. The panel of claim 3, wherein the first yarn and the second yarn each comprise a first fiber having a first tensile strength and a first melting temperature and a second fiber having a second tensile strength less than the first tensile strength and a second melting temperature less than the first melting temperature, wherein the first yarn has a larger percentage of the second fibers than the first fibers and wherein the second yarn has a larger percentage of the first fibers than the second fibers.

18. The panel of claim 3, wherein the first yarn comprises a twisted combination of one ply of high tenacity PET and nine plies of Sheath-Core PET, wherein the second yarn comprises six plies of insulating fiber and two plies of Sheath-Core PET fiber (200 total denier) in a final twist configuration of 40 TPMZ, and wherein the third yarn comprises a twisted combination of two plies of high tenacity PET and one ply of Sheath-Core PET.

19. The panel of claim 3, wherein the panel comprises embedded stiffness regions formed from shrunk portions of the third yarn and omitting the first yarn and the second yarn.

20. The panel of claim 3, wherein the knitted shaped zone is thermoformed.
